(19) United States
(12) Patent Application Publication
(10) Pub. No.: US 2016/0349894 A1
(43) Pub. Date: Dec. 1, 2016

(54) Touchscreen Method and System for Sharing Multimedia Content

(71) Applicant: REMOTE MEDIA, LLC, Wheaton, IL (US)

(72) Inventors: Pavel Savenok, Wheaton, IL (US); Alexander Savenok, Wheaton, IL (US); Gregory H. Leekley, Charlotte, NC (US); Harold Eason, Charlotte, NC (US); David Savenok, Wheaton, IL (US); Daniel E-Lee Yen, Waxhaw, NC (US)

(73) Assignee: REMOTE MEDIA, LLC, Wheaton, IL (US)

(21) Appl. No.: 15/167,644

(22) Filed: May 27, 2016

Related U.S. Application Data
(60) Provisional application No. 62/167,254, filed on May 27, 2015.

(51) Int. Cl. G06F 3/041; G06F 3/0485; G06F 3/0488; G06F 3/0482

(52) U.S. Cl. CPC G06F 3/0414; G06F 3/0482; G06F 3/0485; G06F 3/04883; G06F 3/0416; G06F 2203/04106

(57) ABSTRACT

Computer-touchscreen implemented digital media and multimedia systems and methods include software application tools and related methods that employ first and second types of contact-sensing or input-sensing protocols for registering both simple and pressure contacts at a touchscreen interface for effecting iterative computer functionality based on the degree of either forceful contact with particular applicability to mobile communications devices for the primary purpose of sharing multimedia content. Further, the methods and systems employ contact removal as an action trigger function and as preferably exemplified by a multimedia send/share function. Additional operations may be effected or triggered by repeatedly increasing and decreasing force/input intensity directed into the device and sequencing through low inputs versus high inputs in combination with scrolling or swiping methods. An alternative methodology thus involves low versus high audio input intensity as triggers for various functions analogous to the low versus high force touchscreen input triggers.

### PRIOR HISTORY

This U.S. patent application claims the benefit of U.S. Provisional Patent Application Ser. No. 62/167,254 filed in the United States Patent and Trademark office on 27 May 2015, the specifications and drawings of which are hereby collectively incorporated herein by this reference thereto.

### FIELD OF THE INVENTION

The present invention generally relates to mobile application or software tool operable by way of a computer typified by mobile communications devices having touchscreen functionality. More particularly, the mobile application or software tool according to the present invention operates by way of plurality of types of pressure points directed into a touchscreen of a computer for triggering a plurality of computer functions as exemplified by a terminal step of sending or sharing multimedia content with other users of the mobile application or software tool according to the present invention.

### BACKGROUND OF THE INVENTION

The literature indicates that touchscreen technology may have been first contemplated and/or developed in the mid to late 1960's, which introductory developments were later more fully developed in the early and mid-1970's with U.S. patent application Ser. No. 05/229,870 ('870 application) being filed in the United States Patent and Trademark Office (USPTO) on 28 Feb. 1972 and U.S. patent application Ser. No. 05/452,784 ('784 application) being filed in the USPTO on 18 Mar. 1974. The '870 application later issued into U.S. Pat. No. 3,775,560 ('560 patent) to Ebeling et al. disclosing a so-called Infrared Light Beam X-Y Position Encoder for Display Devices and the '784 application later issued into U.S. Pat. No. 3,911,215 ('215 patent) to Hurst et al. discloses a so-called Discriminating Contact Sensor.

The '560 patent describes a crossed light beam position encoder including X and Y coordinate arrays of paired infrared light sources and detectors for covering a display device surface with X and Y crossed light beams. Certain scanning means are coupled to the sources and detectors for electronically sequentially scanning the x and y arrays so that only one source is emitting light and its associated detector is detecting light at any particular time. Certain other means are included for noting the digital address of the beams during sequential scanning and for stopping the scan when the beams are interrupted, the digital address and therefor the position of the broken beams are transferred back to a computer for registering a touch.

The '215 patent describes a sensor construction for normally maintaining two juxtaposed electrical potential carrying sheets, at least one being flexible, separated from each other but permitting contact therebetween when an object of specified radius of curvature is pressed against the flexible sheet. The separation of the sheets is accomplished by producing discrete small buttons of insulation, preferably on the flexible sheet, with the spacing and the height of the buttons determining the largest radius of curvature to which the sensor will respond. This construction is specifically applied to a telescriber sensor or the like whereby contact is made only by depression of the flexible sheet with a writing instrument and not by any portion of a writer's hand.

Thirty years later, Apple, Inc. filed U.S. patent application Ser. No. 11/322,549 in the USPTO on 23 Dec. 2005, which later issued into U.S. Pat. No. 7,657,849 ('849 patent) disclosing a method of Unlocking a Device by Performing Gestures on an Unlock Manager. The '849 patent describes a device with a touch-sensitive display that may be unlocked via various gestures performed on the touch-sensitive display. The device is unlocked if contact with the display corresponds to a predefined gesture for unlocking the device.

The device displays one or more unlock images with respect to which the predefined gesture is to be performed in order to unlock the device. The performance of the predefined gesture with respect to the unlock image may include moving the unlock image to a predefined location and/or moving the unlock image along a predefined path. The device may also display visual cues of the predefined gesture on the touch screen to remind a user of the gesture. The '849 patent was reportedly made the subject of litigation, however, and earlier prior art developed by the University of Maryland dating from 1990 was said to have disclosed a pertinent touchscreen slider mechanism.

Until more recently, most touchscreen systems were operable to detect a single pressure or contact point at a time, and reportedly few have had the capability to sense how hard one is touching. Emerging multi-touch touchscreen technology provides touchscreen surfacing that senses multipoint surface contacts. This plural-point awareness may be used to implement additional functionality, such as “pinch-to-zoom” functionality, or for activating certain other operations.

From a review of the foregoing citations in particular, and from a consideration of the prior art in general, it will be seen that the prior art perceives a need for touchscreen technology that senses both low force simple contact and high force pressure contact with the touchscreen each of which types of touchscreen contact may operate to trigger differing and iterative device functions. Further, the prior art perceives a need for touchscreen technology that senses touchscreen contact removal or touchscreen contact cessation for further triggering a proactive function as exemplified by a multimedia send/share function as summarized according to the present invention in more detail hereinafter.

### SUMMARY OF THE INVENTION

Among the many objectives of this invention is the basic provision of a computer-implementable mobile application, software tool or non-transitory computer readable medium with executable instructions executable by a computer such as a tablet type computer, mobile phone, or similar other mobile communications device. The mobile communications device usable in combination with the mobile application or software tool development according to the present invention necessarily comprises or includes a touchscreen, an electronic visual display, and a central processing unit or information processing system.

The touchscreen according to the present invention is preferably made operable by way of a combination of at least two contact-sensing systems driven, governed or controlled by the information processing system whereby a first of the at least two contact-sensing systems operates when relatively minimized force and simple contact is initiated between a contacting member such as a stylus or human fingertip and the touchscreen and a second of the at least two contact-sensing systems operates when relatively maximized force or a pressure contact is initiated between the contacting member and the touchscreen. Thus the touchscreen and touchscreen methods according to the present invention operate by way of both simple (low force) contact and pressure (high force) contact.

General types of touch-sensing or contact-sensing systems associated with touchscreen technology may be generally depicted as either simple resistive type touchscreen systems versus capacitive type touchscreen systems for ease of understanding. A traditional resistive touchscreen typically accepts a material deformation at outer layers via a directed force contact to close a circuit between stationary and deforming layers for creating a “touch: signal deliverable to the information processing system for further processing. In contrast to the resistive touchscreen technology, capacitive touchscreens undergo negligible deformation. When a charged contacting member such as a fingertip is directed into the capacitive touchscreen assembly, a change in the electric field occurs at the touch point and a signal is deliverable to the information processing system for further processing. Other touchscreen technologies may be employed to approximate or mimic the basic effects of these two exemplary touchscreen systems.

It will be understood from a consideration of the following descriptions that the mobile application or software tool according to the present invention further provides an off state or contact-removed state as a prompt that triggers further operability. In this regard, the present invention contemplates provides two-state touchscreen operability whereby a first of the two states is a contact state (i.e. either a low force simple contact state or a high force pressure contact state) and the second of the two states is a contact-removed state or contact cessation state. A pre-contact state is a no contact state and thus an initial contact must be made to initiate the methodology. Once initiated the contact-removed state or contact cessation state does not trigger function cessation, but triggers a “begin” or proactive function whereby action is initiated or triggered.

In the preferred methodology or system, the mobile application or software tool according to the present invention provides three-state touchscreen operability, including a low force simple contact state; a high force pressure contact state; and contact-removed or contact cessation state. Changes in contact pressure, when meeting or passing a threshold value defining the low versus high force states operate to govern functionality, and may result from either increases in pressure or decreases in pressure. Further, once initiated, an off state as in a contact removed state, triggers a further function as preferably exemplified by a send or share function.

The computer implemented method or computer-based system according to the present invention thus basically operates to perform successive computer functions via engagement with and disengagement from a computer-based touchscreen. The computer implemented method, for example, may be said to basically and essentially comprise the steps of initially contacting a computer touchscreen for initiating a first computer function; increasing directed force into the computer touchscreen for initiating a second computer function sequentially successive to the first computer function; and decreasing directed force into the computer touchscreen for initiating a third computer function sequentially successive to the second computer function. A further step of ceasing contact with the computer touchscreen may initiate a fourth computer function sequentially successive to the third computer function.

The first computer function may be initiated by a first touch-sensing or contact-sensing system cooperable with the touchscreen and the second computer function may be initiated by a second touch-sensing or contact-sensing system cooperable with the touchscreen. The step of decreasing directed force into the computer touchscreen may be further defined or refined by the added aspect of maintaining contact with the computer touchscreen before disengaging therefrom. In other words, a decreased force followed by a maintained or unchanging force with minimal contact operates to trigger additional functionality. It thus follows that steps of increasing and decreasing directed force into the computer touchscreen may be repeated for initiating additional computer functions sequentially successive to the other computer function.

A further aspect of the present invention involves various deformations that may occur at the member-to-screen interface or that plane where contact occurs. In this regard, it is contemplated that the step of increasing directed force into the computer touchscreen may be characterized by deformation of at least a portion of the computer touchscreen or alternatively may be characterized by a deformation of at least a portion of a contacting member. In the latter case scenario, the deformation of at least a portion of the contacting member may operate to increase a contact surface area between the contacting member and the touchscreen, which increased contact surface area may trigger or initiate additional operations. Similarly, a decrease in contact surface area or a return to a relaxed, un-deformed screen state may trigger additional operations. Other objects of the present invention, as well as particular features, elements, and advantages thereof, will be elucidated or become apparent from, the following description and the accompanying drawing figures.

### BRIEF DESCRIPTION OF THE DRAWINGS

Other features and objectives of the invention will become more evident from a consideration of the following brief descriptions of patent drawings:

FIG. 1 is a first sequential depiction of a mobile communications device implementing the mobile application or software tool according to the present invention showing a touchscreen in a pre-contact state with a fragmentary finger being directed toward a visual prompt displayed upon an electronic visual display cooperable with the touchscreen.

FIG. 1A is a diagrammatic depiction of a (pre-contact) no-contact state between a contacting member as exemplified by a fingertip and the surface of the touchscreen, which diagrammatic depiction coincides with the first sequential depiction otherwise depicted in FIG. 1.

FIG. 2 is a second sequential depiction of the mobile communications device implementing the mobile application or software tool according to the present invention showing the touchscreen in an initial low force simple contact state by way of the fragmentary finger initiating contact with the touchscreen at the visual prompt site as displayed upon the electronic visual display, which low force simple contact state triggers the capture of a photograph/video represented by a first thumbnail of the captured photograph/video as a photographic/video content packet or file upon the electronic visual display.

FIG. 2A is a diagrammatic depiction of an initial low force simple contact state between the fingertip contacting member and the surface of the touchscreen, which diagrammatic depiction coincides with the second sequential depiction otherwise depicted in FIG. 2.

FIG. 3 is a third sequential depiction of the mobile communications device implementing the mobile application or software tool according to the present invention showing the touchscreen in a second high force pressure contact state by way of the fragmentary finger initiating pressure contact with the touchscreen at the visual prompt site as displayed upon the electronic visual display, which high force pressure contact state triggers an enlarged view of the captured photograph/opening video screenshot for review upon the electronic visual display.

FIG. 3A is a diagrammatic depiction of a high force pressure contact state between the fingertip contacting member and the surface of the touchscreen, which diagrammatic depiction coincides with the third sequential depiction otherwise depicted in FIG. 3.

FIG. 4 is a fourth sequential depiction of the mobile communications device implementing the mobile application or software tool according to the present invention showing the touchscreen in a contact-removed state with a fragmentary finger being directed away from the touchscreen, which contact-removed state triggers a send/share function for sharing the photographic/video content packet with others.

FIG. 4A is a diagrammatic depiction of a contact-removed state between the fingertip contacting member and the surface of the touchscreen, which diagrammatic depiction coincides with the fourth sequential depiction otherwise depicted in FIG. 4.

FIG. 5 is a fifth sequential depiction of the mobile communications device implementing the mobile application or software tool according to the present invention showing the touchscreen in a low force simple contact state by way of the fragmentary finger maintaining contact with the touchscreen at the visual prompt site as displayed upon the electronic visual display, which low force simple contact state triggers the display of a menu listing upon the electronic visual display.

FIG. 5A is a diagrammatic depiction of the low force simple contact state between the fingertip contacting member and the surface of the touchscreen, which diagrammatic depiction coincides with the fifth sequential depiction otherwise depicted in FIG. 5.

FIG. 6 is a sixth sequential depiction of the mobile communications device implementing the mobile application or software tool according to the present invention showing the touchscreen in a low force simple contact state by way of the fragmentary finger maintaining vertically displacing contact with the touchscreen at the menu listing as displayed upon the electronic visual display, which low force simple contact state scrolls through the menu listing display upon the electronic visual display.

FIG. 6A is a diagrammatic depiction of the low force simple contact state between the fingertip contacting member and the surface of the touchscreen, which diagrammatic depiction coincides with a first fingertip position shown in solid lining as otherwise depicted in FIG. 6.

FIG. 6B is a diagrammatic depiction of the low force simple contact state between the fingertip contacting member and the surface of the touchscreen, which diagrammatic depiction coincides with a second fingertip position shown in broken lining as otherwise depicted in FIG. 6.

FIG. 7 is a seventh sequential depiction of the mobile communications device implementing the mobile application or software tool according to the present invention showing the touchscreen in a high force pressure contact state by way of the fragmentary finger initiating pressure contact with the touchscreen at a select visual prompt as selected from the menu listing as displayed upon the electronic visual display, which high force pressure contact state triggers the selection of content as represented by the select visual prompt.

FIG. 7A is a diagrammatic depiction of the high force pressure contact state between the fingertip contacting member and the surface of the touchscreen, which diagrammatic depiction coincides with the seventh sequential depiction otherwise depicted in FIG. 7.

FIG. 8 is an eighth sequential depiction of the mobile communications device implementing the mobile application or software tool according to the present invention showing the touchscreen in a low force simple contact state by way of the fragmentary finger maintaining contact with the touchscreen at the select visual prompt as displayed upon the electronic visual display, which low force simple contact state triggers audio playback of the content represented by the select visual prompt upon the electronic visual display.

FIG. 8A is a diagrammatic depiction of the low force simple contact state between the fingertip contacting member and the surface of the touchscreen, which diagrammatic depiction coincides with the eighth sequential depiction otherwise depicted in FIG. 8.

FIG. 9 is a ninth sequential depiction of the mobile communications device implementing the mobile application or software tool according to the present invention showing the touchscreen in a high force pressure contact state by way of the fragmentary finger initiating pressure contact with the touchscreen at the select visual prompt as displayed upon the electronic visual display, which high force pressure contact state triggers a (timer) start function for selecting a beginning portion of the content for sharing with others.

FIG. 9A is a diagrammatic depiction of the high force pressure contact state between the fingertip contacting member and the surface of the touchscreen, which diagrammatic depiction coincides with the ninth sequential depiction otherwise depicted in FIG. 9.

FIG. 10 is a tenth sequential depiction of the mobile communications device implementing the mobile application or software tool according to the present invention showing the touchscreen in a low force simple contact state by way of the fragmentary finger maintaining contact with the touchscreen at the select visual prompt as displayed upon the electronic visual display, which low force simple contact state maintains audio playback of the content represented by the select visual prompt upon the electronic visual display while time elapses for selecting a body portion of the content for sharing with others.

FIG. 10A is a diagrammatic depiction of the low force simple contact state between the fingertip contacting member and the surface of the touchscreen, which diagrammatic depiction coincides with the tenth sequential depiction otherwise depicted in FIG. 10.

FIG. 11 is an eleventh sequential depiction of the mobile communications device implementing the mobile application or software tool according to the present invention showing the touchscreen in a high force pressure contact state by way of the fragmentary finger initiating pressure contact with the touchscreen at the select visual prompt as displayed upon the electronic visual display, which high force pressure contact state triggers a (timer) end function for selecting an end portion that creates an audio content packet represented by a second thumbnail upon the electronic visual display for sharing with others.

FIG. 11A is a diagrammatic depiction of the high force pressure contact state between the fingertip contacting member and the surface of the touchscreen, which diagrammatic depiction coincides with the ninth sequential depiction otherwise depicted in FIG. 11.

FIG. 12 is a twelfth sequential depiction of the mobile communications device implementing the mobile application or software tool according to the present invention showing the touchscreen in a low force simple contact state by way of the fragmentary finger maintaining contact with the touchscreen at the select visual prompt as displayed upon the electronic visual display, which low force simple contact state attaches the audio content packet to the photographic/video content packet for forming a combination photographic/video-audio content packet represented by a third thumbnail upon the electronic visual display for sharing with others.

FIG. 12A is a diagrammatic depiction of the low force simple contact state between the fingertip contacting member and the surface of the touchscreen, which diagrammatic depiction coincides with the tenth sequential depiction otherwise depicted in FIG. 12.

FIG. 13 is a thirteenth sequential depiction of the mobile communications device implementing the mobile application or software tool according to the present invention showing the touchscreen in a contact-removed state with a fragmentary finger being directed away from the touchscreen, which contact-removed state triggers a send/share function for sharing the combination photographic/video-audio content packet with others.

FIG. 13A is a diagrammatic depiction of a contact-removed state between the fingertip contacting member and the surface of the touchscreen, which diagrammatic depiction coincides with the fourth sequential depiction otherwise depicted in FIG. 13.

FIG. 14 is a fourteenth sequential depiction of the mobile communications device implementing the mobile application or software tool according to the present invention showing the touchscreen in a high force pressure contact state by way of the fragmentary finger initiating pressure contact with the touchscreen at the select visual prompt as displayed upon the electronic visual display, which high force pressure contact state triggers a microphone or audio input function for creating an audio commentary packet represented by a microphone image upon the electronic visual display.

FIG. 14A is a diagrammatic depiction of the high force pressure contact state between the fingertip contacting member and the surface of the touchscreen, which diagrammatic depiction coincides with the ninth sequential depiction otherwise depicted in FIG. 14.

FIG. 15 is a fifteenth sequential depiction of the mobile communications device implementing the mobile application or software tool according to the present invention showing the touchscreen in a low force simple contact state by way of the fragmentary finger maintaining contact with the touchscreen at the select visual prompt as displayed upon the electronic visual display, which low force simple contact state attaches an audio commentary packet to the photographic/video content packet and the audio content packet for forming a combination photographic/video-audio-commentary packet represented by a fourth thumbnail upon the electronic visual display for sharing with others.

FIG. 15A is a diagrammatic depiction of the low force simple contact state between the fingertip contacting member and the surface of the touchscreen, which diagrammatic depiction coincides with the tenth sequential depiction otherwise depicted in FIG. 15.

FIG. 16 is a sixteenth sequential depiction of the mobile communications device implementing the mobile application or software tool according to the present invention showing the touchscreen in a contact-removed state with a fragmentary finger being directed away from the touchscreen, which contact-removed state triggers a send/share function for sharing the combination photographic/video-audio-commentary packet with others.

FIG. 16A is a diagrammatic depiction of a contact-removed state between the fingertip contacting member and the surface of the touchscreen, which diagrammatic depiction coincides with the fourth sequential depiction otherwise depicted in FIG. 16.

FIG. 17 is a seventeenth sequential depiction of the mobile communications device implementing the mobile application or software tool according to the present invention showing the touchscreen in a high force pressure contact state by way of the fragmentary finger maintaining horizontally displacing pressure contact with the touchscreen for effecting further functionality.

FIG. 17A is a diagrammatic depiction of the high force pressure contact state between the horizontally displacing fingertip contacting member and the surface of the touchscreen, which diagrammatic depiction coincides with a first fingertip position shown in solid lining as otherwise depicted in FIG. 17.

FIG. 17B is a diagrammatic depiction of the high force pressure contact state between the horizontally displacing fingertip contacting member and the surface of the touchscreen, which diagrammatic depiction coincides with a second fingertip position shown in broken lining as otherwise depicted in FIG. 17.

FIG. 18 is a fragmentary diagrammatic depiction of a generic resistive type touchscreen assembly showing a fingertip being directed into the touchscreen assembly for deforming external layering of the touchscreen assembly for registering a touch.

FIG. 19 is a fragmentary diagrammatic depiction of a generic capacitive type touchscreen assembly showing a fingertip making electrostatic contact with the touchscreen assembly for registering a touch.

FIG. 20 is a fragmentary diagrammatic depiction of a generic internal light reflective type touchscreen assembly showing a fingertip scattering light within the touchscreen assembly for registering a touch.

FIG. 21 is a combination state diagram showing from top to bottom (1) a no-contact or contact-removed state between a fingertip contacting member and a touchscreen; (2) a low force simple contact state between a fingertip contacting member and a touchscreen; and (3) a high force pressure contact state between a fingertip contacting member and a touchscreen.

FIG. 21A is a diagrammatic depiction of a relatively reduced contact surface area of the low force simple contact state between the fingertip contacting member and touchscreen otherwise depicted in FIG. 21.

FIG. 21B is a diagrammatic depiction of a relatively enlarged contact surface area of the high force pressure contact state between the fingertip contacting member and touchscreen otherwise depicted in FIG. 21.

FIG. 22A is a diagrammatic depiction of an increasing contact surface area as increasing force is directed into a rigid touchscreen and the contact surface area between the fingertip contacting member and touchscreen increases.

FIG. 22B is a diagrammatic depiction of a decreasing increasing contact surface area as decreasing force is directed into a rigid touchscreen and the contact surface area between the fingertip contacting member and touchscreen decreases.

FIG. 23 is a first sequential depiction of the mobile communications device implementing an alternative method contemplated by the mobile application or software tool according to the present invention showing (a) a relatively small microphone visual prompt upon the visual display for signaling to the user that a first auditory input will initiate a first device function, and (b) a relatively low intensity audio input being directed into an audio input feature of the device for initiating the first device function.

FIG. 24 is a second sequential depiction of the mobile communications device implementing an alternative method contemplated by the mobile application or software tool according to the present invention showing (a) a relatively large microphone visual prompt upon the visual display for signaling to the user that a second, relatively higher intensity auditory input will initiate a second device function, and (b) a relatively high intensity audio input being directed into the audio input feature of the device for initiating the second device function.

FIG. 25 is a diagrammatic depiction of a sound intensity chart showing from bottom to top an imperceptible auditory intensity threshold level, a relatively low intensity auditory input level for initiating a first device function; a relatively high intensity auditory input level for initiating a second device function, and a highest intensity auditory input level.

### DETAILED DESCRIPTION OF THE PREFERRED METHODOLOGY AND SYSTEM

Referencing the drawings now with more specificity, the present invention basically provides a computer-implementable mobile application, software tool or non-transitory computer readable medium with executable instructions executable by a computer such as a tablet type computer, mobile phone, or similar other mobile communications device as generically depicted and referenced at 10. The mobile communications device 10 usable in combination with the mobile application or software tool development according to the present invention necessarily comprises or includes a touchscreen as at 11, an electronic visual display as at 12, and a central processing unit or information processing system 13 in communication with the touchscreen 11 and visual display 12.

The touchscreen 11 according to the present invention is preferably made operable by way of a combination of at least two touch-sensing or contact-sensing systems driven, governed or controlled by the information processing system 13 and whereby a first of the at least two systems operates when relatively minimized force and/or simple contact is initiated between a contacting member such as a stylus or human fingertip (as at 14) and the touchscreen 11. Diagrammatic depictions of minimized force/simple contact scenarios are generally referenced at 100 throughout the drawings submitted in support of these specifications. Referencing numeral 100, the reader will there note a relatively minimized force 101 directed into the touchscreen 11 via the contacting member or fingertip 14.

Minimized force or low force 101 simple contact scenarios or states 100 preferably coincide with touch-sensing or contact-sensing systems characterized by simple contact signal input as may be preferably exemplified by capacitive touch-sensing or contact-sensing systems as generically and diagrammatically depicted in FIG. 19. In contrast to the minimized or low force 101 simple contact scenarios or states 100, relatively higher pressure-input or high force 103 touch-sensing scenarios or states are diagrammatically depicted and generally referenced at 102 throughout the drawings. High force 103 scenarios or states 102 represent a second of the at least two touch-sensing or contact-sensing systems operable according to the touchscreen 11 and touchscreen methodologies according to the present invention.

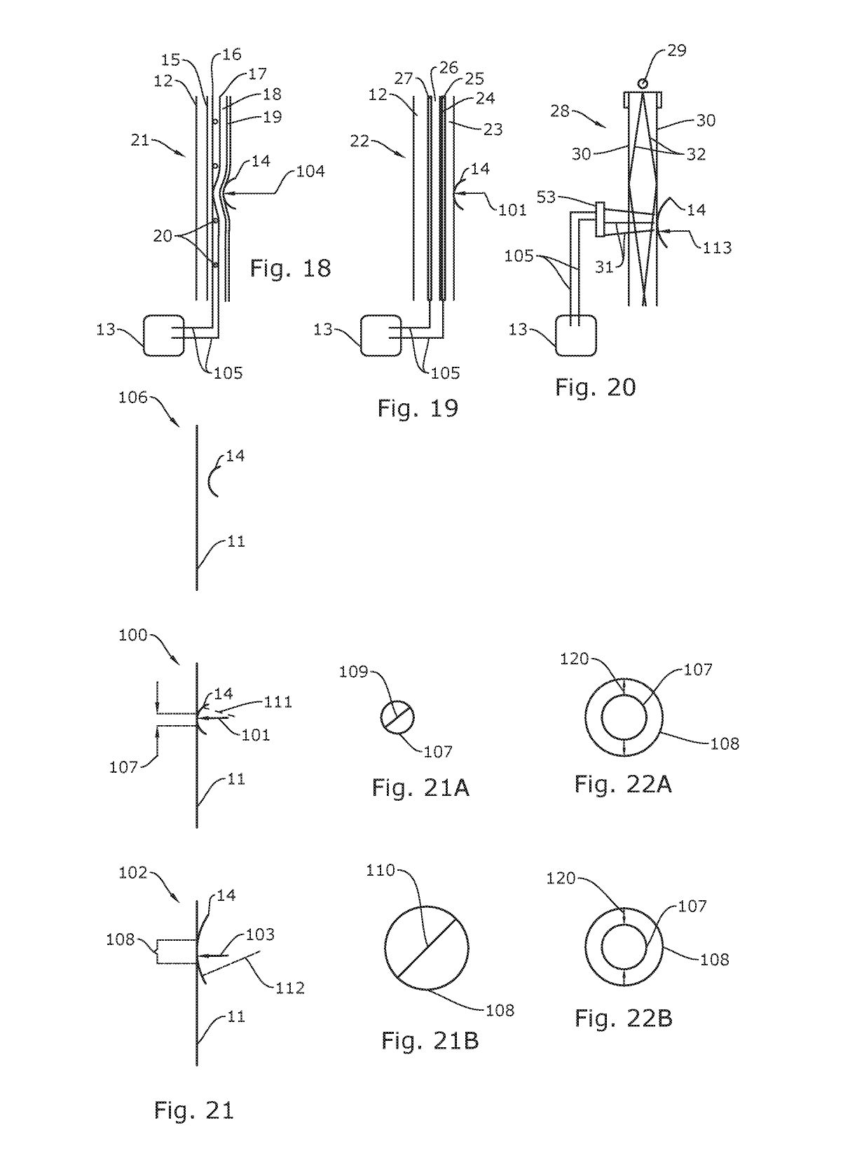

Thus the touchscreen 11 according to the present invention operates by way of both simple (low force) contact and pressure (high force) contact. A relatively increased force or force of greater degree 103 is thus seen being directed into the touchscreen 11 via a contacting member such as a stylus or human fingertip (as at 14) in the scenarios or states referenced at 102. These types of touch-sensing or contact-sensing systems 102 are generally depicted as simple resistive type touchscreen systems as compared to capacitive systems for ease of illustration and understanding. A generic or simple resistive type touchscreen system is depicted and referenced in FIG. 18 in side-by-side relation to FIG. 19 (a simple capacitive system) for further ease of comparison.

A traditional resistive touchscreen typically comprises an electronic visual display as at display 12 as may be preferably exemplified by a Liquid Crystal Display or LCD screen; a substantially rigid substrate layer as at 15; a first conductive layer as at 16; a second conductive layer as at 17; a deformable layer as at 18; and an outer polymeric and deformable film layer as at 19. Spacer elements 20 maintain a normal distance between the conductive layers 16 and 17 and when a force 104 is directed into the multilayer touchscreen assembly 21 as generally depicted in FIG. 18, a deformation occurs of the layers 17-19 to close a circuit between conductive layers 16 and 17 for creating a signal deliverable to the information processing system 13 via circuitry 105 for further processing.

Referencing FIG. 19 the reader will there consider a traditional capacitive touch-sensing system or touchscreen assembly 22. In contrast to the resistive touchscreen assembly 21, the capacitive touchscreen assembly 22 undergoes no or negligible deformation though a relatively small force 101 may be directed thereagainst via a fingertip 14. The outermost layer is thus a substantially rigid (glass/film) layer 23 followed by a conductive layer 24, an insulative layer 25; a rigid (glass/film) layer 26; a conductive layer 27, and an electronic visual display as at display 12. When a charged contacting member or fingertip 14 is directed (as at force 101) into the multilayer touchscreen assembly 22, a change in the electric field occurs at the touch point and a signal is deliverable to the information processing system 13 via circuitry 105 for further processing.

The resistive and capacitive touchscreen assemblies 21 and 22 generically depicted in FIGS. 18 and 19 are presented to support the basic concepts of a both a pressure-based (or force-based) touchscreen assembly as at 21 and a contact-based touchscreen assembly as at 22. The touchscreen 11 according to the present invention overlies an electronic visual display 12 and provides features of both a pressure-based (or force-based) touchscreen assembly as at 21 and a contact-based touchscreen assembly as at 22. Other touchscreen technology, however, may be employed to approximate or mimic the effects of these two features. A light-scattering or light wave-interruptive touchscreen assembly 28, for example, is generically depicted in FIG. 20.

It is contemplated that a simple, low force contact as at 101 involves a force of at least some small magnitude. A highly sensitive touchscreen assembly as perhaps exemplified by either an internal light-reflective type touchscreen assembly (as at 28) or an infrared type touchscreen assembly (not specifically illustrated) is able to register relatively low force 101 contact scenarios as generally depicted at 100. Assembly 28, by way of example, may incorporate an LED 29 for emitting light 32 and opposed light-reflective boundaries as at 30. A fingertip touch as at 113 will scatter light as at 31, which scattered light 31 is detected as at detector 53 and a signal is directed to the information processing system 13 for registering a particular type of touch. In other words, the degree of light scattering associated with the touch 113 may thus be registered as either a low force 101 touch or high force 103 touch.

Relatively high(er) force 103 contact scenarios 102 are conceivably also easily registrable or detectable and deformations thereby result in light-scattering events on a something of a sliding scale in terms of magnitude. When a threshold deformation, contacted surface area, light-scattering, or wave-interruptive event occurs, the ensuing signal can thus be registered as either a high force 103 contact event or scenario 102 if force is being increased above the threshold or a low force 101 contact event or scenario 100 if force is being reduced below the threshold. Various computer functions may thus be triggered according to the threshold force input being met as determined from deformation levels, light-scattering events, or wave-interruptive events.

Alternatively, if a touchscreen is provided that undergoes negligible or no deformation, it is contemplated that the contacting member as exemplified by a tissue-based fingertip 14 will necessarily undergo a deformation when pressed against an otherwise rigid layer. Referencing FIG. 21, the reader will there comparatively consider a no-contact or member-removed scenario as at 106; a low force 101 simple contact scenario as at 100; and a high force 103 contact scenario as at 102. A low force 101 simple contact fingerprint or member contact surface area is generally depicted and referenced at 107, and a high force 103 pressure contact fingerprint or contact surface area is generally depicted and referenced at 108.

It should be noted that contact surface area 107, as circularly depicted, coincides with a fingertip 14 having a diameter 109 that is relatively lesser in magnitude as compared to the diameter 110 for contact surface area 108. In other words, and from a side perspective, the low force 101, simple contact, relaxed fingertip 14 shown in FIG. 21 has a relatively reduced radius of curvature 111 as compared to the high force 103 pressure contact, deformed fingertip 14 having a relatively increased radius of curvature 112. Referencing FIGS. 22A and 22B, the reader will there comparatively consider an increasing contact surface area 107 to 108 (FIG. 22A) versus a decreasing contact surface area 108 to 107 (FIG. 22B). The increase as at 120 or the decrease as at 121 thus represent a change in contact surface area. When the change in contact surface area meets a threshold, further operability is triggered according to the present invention.

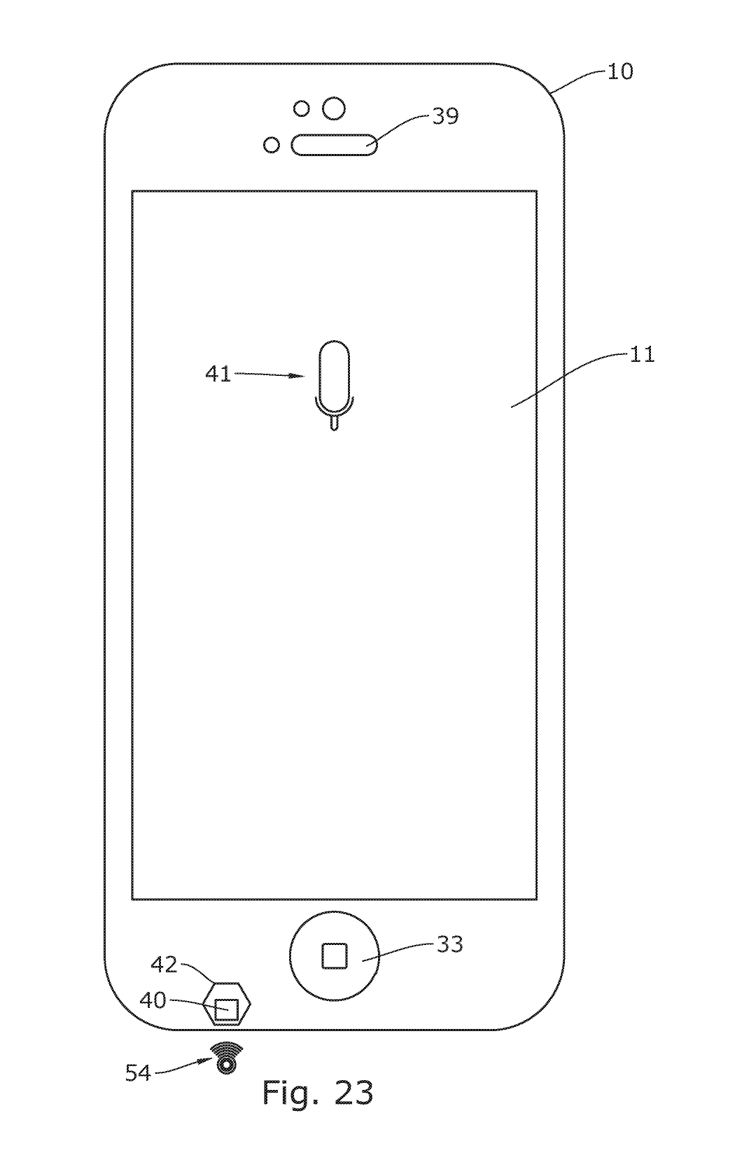

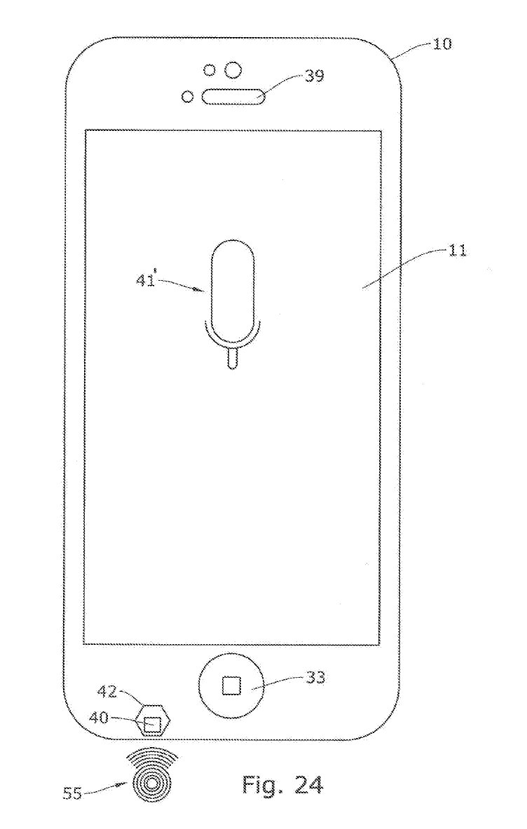

In an alternative methodology, and in keeping with the notion of low force versus high force contact scenarios, it is contemplated that varying device functionality may also be triggered by decibel level or sound intensity so that a voice-activation/control or sound-activation/control of the device 10 can be achieved. In this regard, it is contemplated that such methodology might be particularly helpful for users with visual disabilities and may not be able to visually perceive the visual prompt 35. For those with sufficient visual acuity, the present invention contemplates visual prompt 41 for signaling to the user that the microphone or audio input feature 40 is enabled as generally depicted in FIGS. 23 and 24.

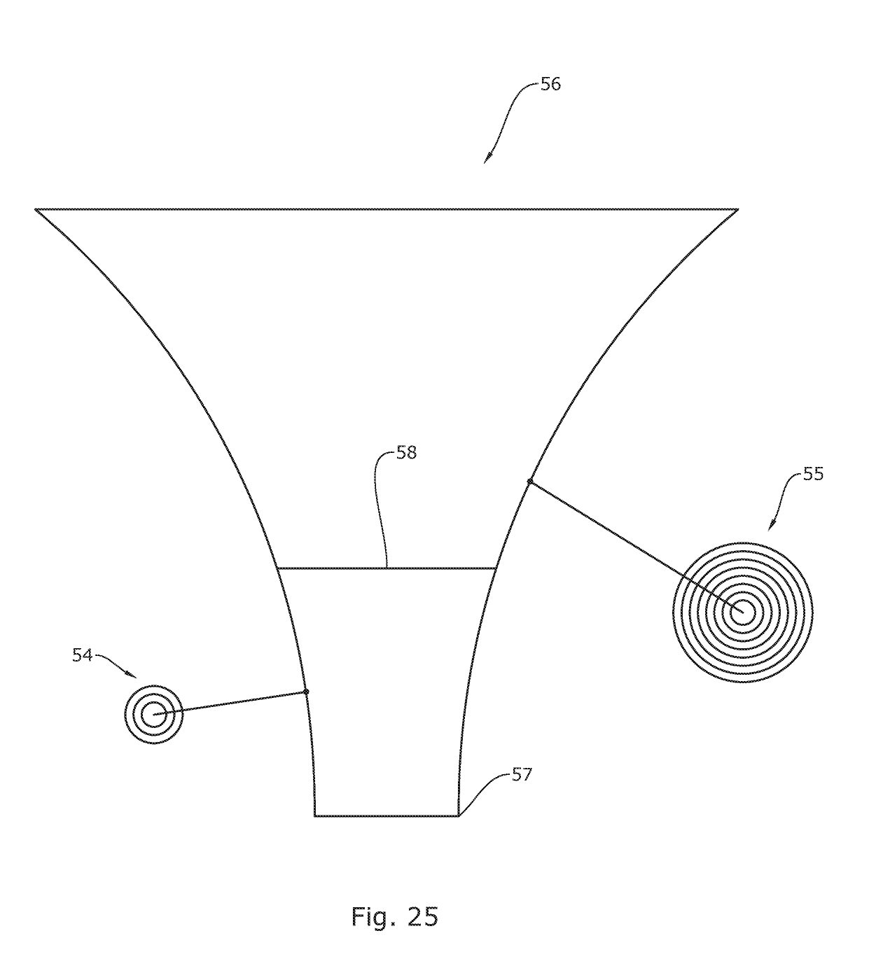

Referencing FIG. 23, the reader will there consider a relatively low intensity audio input as at 54 and a relatively small (microphone) visual prompt 41. Low intensity audio input 54 in this scenario is akin to the low force 101 simple contact 100 scenario discussed hereinabove. Further, comparatively referencing FIG. 24, the reader will there consider a relatively high intensity audio input as at 55 a relatively large (microphone) visual prompt as at 41′, which relatively high intensity audio input 55 is akin to the high force 103 pressure contact 102 scenario. The intensity chart 56 generally depicted in FIG. 25 depicts the relatively high intensity audio input 55 in an elevated position relative to the relatively low intensity audio input as at 54. Given some intervening defined threshold as at 58, a relatively low or high intensity audio input as at 54 or 55 may be used to control device functionality based on auditory input levels.

A relatively high intensity audio input 55, for example, might be implemented to initiate an auditory menu or listing playable via a device speaker feature as at 39, and a relatively low auditory input 54 might be implemented to maintain the menu playback. When a desired auditory file is announced via the speaker, the user may initiate a high intensity auditory input 55 to choose the selected or desired audio file for further processing. The present invention thus contemplates low versus high signal inputs as a means for controlling device functionality for the primary purpose of sending/sharing multimedia content with others via the mobile application or software tool according to the present invention.

It will thus be understood that the mobile application or software tool according to the present invention, at minimum, provides two-state touchscreen operability whereby a first of the two states is a contact or low intensity state (i.e. either a low force 101 simple contact state 100 or a high force 103 pressure contact state 102 or alternatively a low intensity auditory input state as at 54 versus a high intensity auditory input state as at 55) and the second of the two states is a contact-removed state or contact cessation state as at 106 (or an imperceptible auditory input state as at threshold level 57). A pre-contact state is also a no contact state, but an initial contact must be made to initiate the touchscreen methodology according to the present invention. It should also be noted that once the touchscreen methodology according to the present invention is initiated by way of a contact, a later-occurring contact-removed state or contact cessation state 106 does not trigger function cessation, but triggers a begin function such as the send/share function herein described.

In the preferred methodology or system, the mobile application or software tool according to the present invention provides three-state touchscreen or auditory input operability, including a low force 101 simple contact state 100; a high force 103 pressure contact state 102; and a contact-removed state or contact cessation state 106. If X=the initiating contact or intensity state, and ΔX=a change in the initiating contact or intensity state, then ΔX′ may be considered the threshold contact or intensity state that triggers successive or iterative functionality. The ΔX′ is the threshold contact or intensity state and may result from an increase in pressure or a decrease in pressure or contact surface area directed into the touchscreen 11. Further, once initiated, an off state as in a contact removed state 106 results in further operability as exemplified by a multimedia content send/share function.

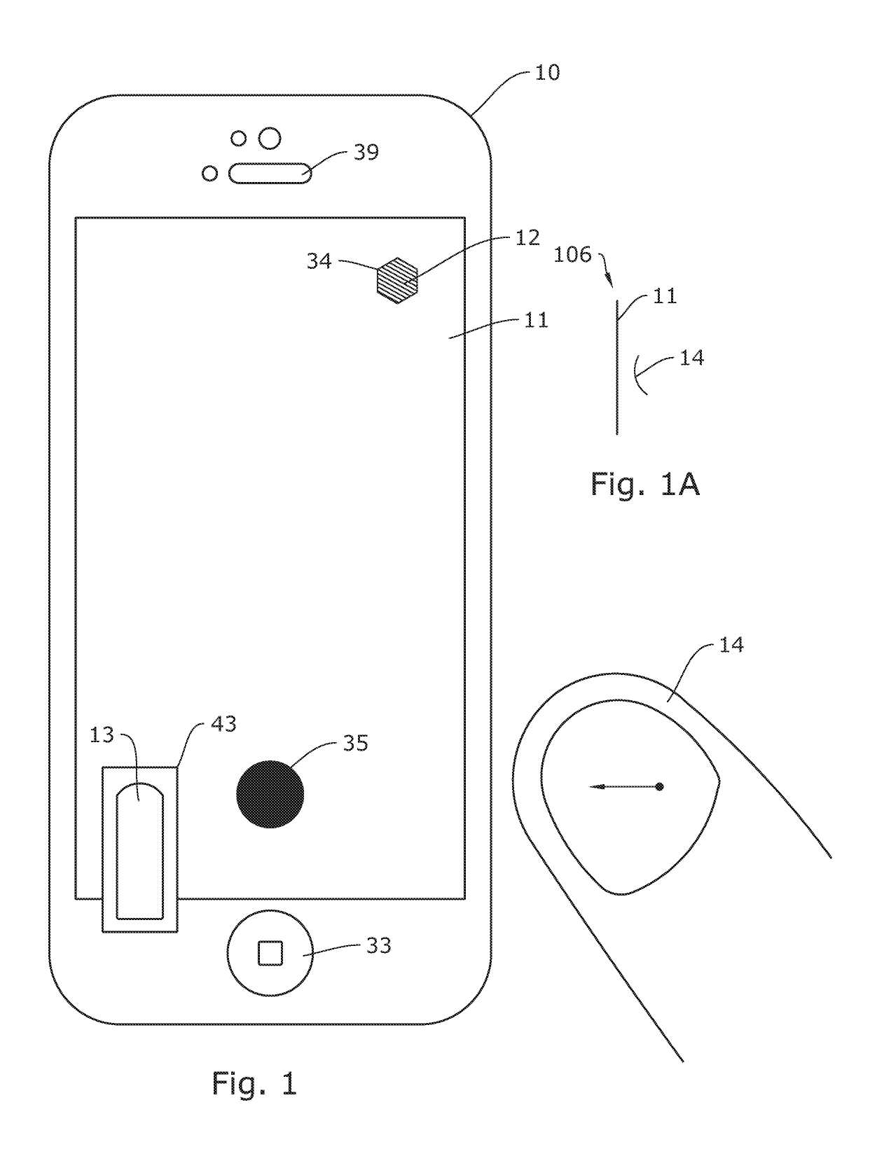

Referencing FIGS. 1-4, the reader will there consider a firstly illustrated mobile communications device 10. A set of functions are enabled by the mobile communications device by virtue of its basic or consumer sold functionality. In cooperation with the mobile application or software tool according to the present invention, the mobile device 10 provides the user with additional touchscreen-based methodology. In FIG. 1, the reader will there see mobile communications device 10 typified by a mobile phone having certain computing capability. The mobile communications device 10 may be considered a hand held computer. The computer or mobile communications device 10, as illustrated in FIG. 1, basically comprises a control button as at 33 and a touchscreen as at 11. Both button 33 and touchscreen 11 may be considered touch-based data input means.

Certain parts of the touchscreen assembly 11 are broken away at hexagonally shaped breakaway 34 to reveal the underlying electronic visual display 12 upon which electronic visual display 12 visual imagery may be displayed. A visual button-shaped prompt 35 is displayed upon the electronic visual display 12 at a launch screenshot of the mobile application or software tool for prompting the user and initiating device or computer functionality according to the present invention. FIG. 1 thus generally depicts a visual prompt or initiating step according to the present invention. The device-driving or controlling information or central processing system is generically depicted at oblong box 13 via rectangular shaped breakaway 43.

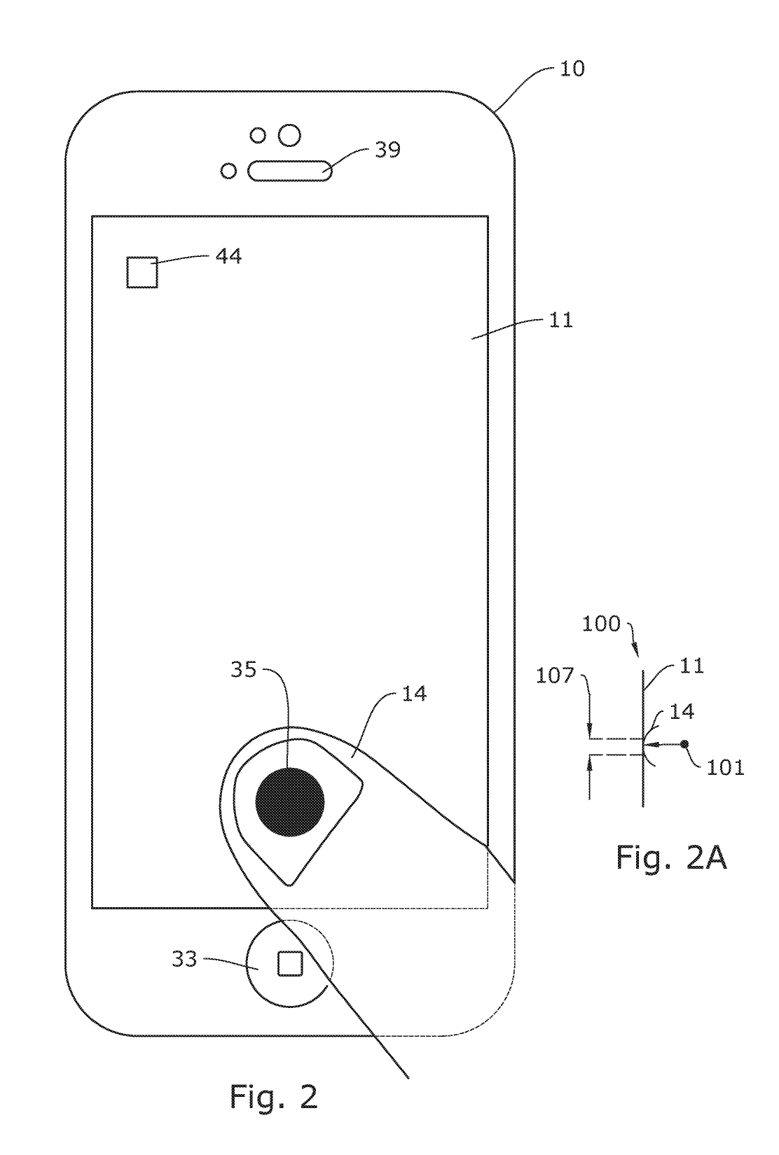

Referencing FIG. 2, the user may place or position his or her contacting member as exemplified by a fingertip 14 over the visual prompt 35 and initiate a low force 101 simple contact scenario 100 with the touchscreen 11. By so contacting the touchscreen 11, the user may for example, snap a photograph (i.e. a first computer function) or initiate a video recording (i.e. a second computer function) provided the mobile communications device 10 is programmed with such computer functionality and is outfitted with further data input means such as a camera or video content recorder. A snapshot photograph/video packet or file 44 is represented by a thumbnail photographic/video visual display upon the screen 12. The process of initiating functionality of a mobile communications device 10 by making low force 101 simple contact 100 with a visual prompt is believed to be state of the art. The present invention builds upon this art by basically providing dual contact force-triggering functionality as prefaced above.

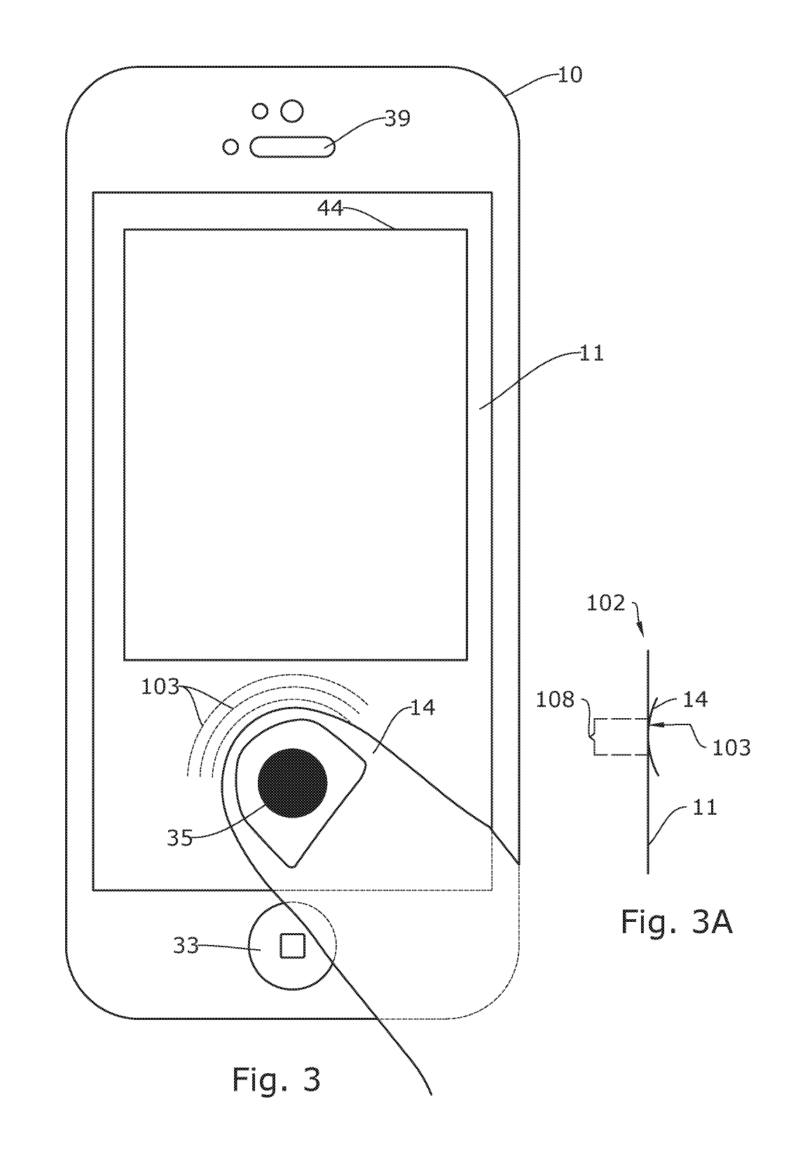

Referencing FIG. 3 then, the reader will there see a depiction of the user force-pressing the visual prompt 35. In other words, a high force 103 pressure contact scenario 102 is made at the site of the visual prompt 35. In this functionality scenario, the photograph or video as represented by 44 taken by way of the low force 101 simple contact 100 otherwise depicted in FIG. 2 is enlarged or displayed upon the electronic visual display 12 (i.e. a third computer function) which display is triggered by the high force 103 pressure contact at the visual prompt 35. If a video were to be alternatively taken or recorded by maintaining a low force 101 simple contact 100 upon the visual prompt 35 (not specifically illustrated), the video recording may cease (i.e. a fourth computer function) upon the high force 103 pressure contact 102 trigger, and the first screen shot of the recorded video may be displayed upon the visual display 12 for review by the user.

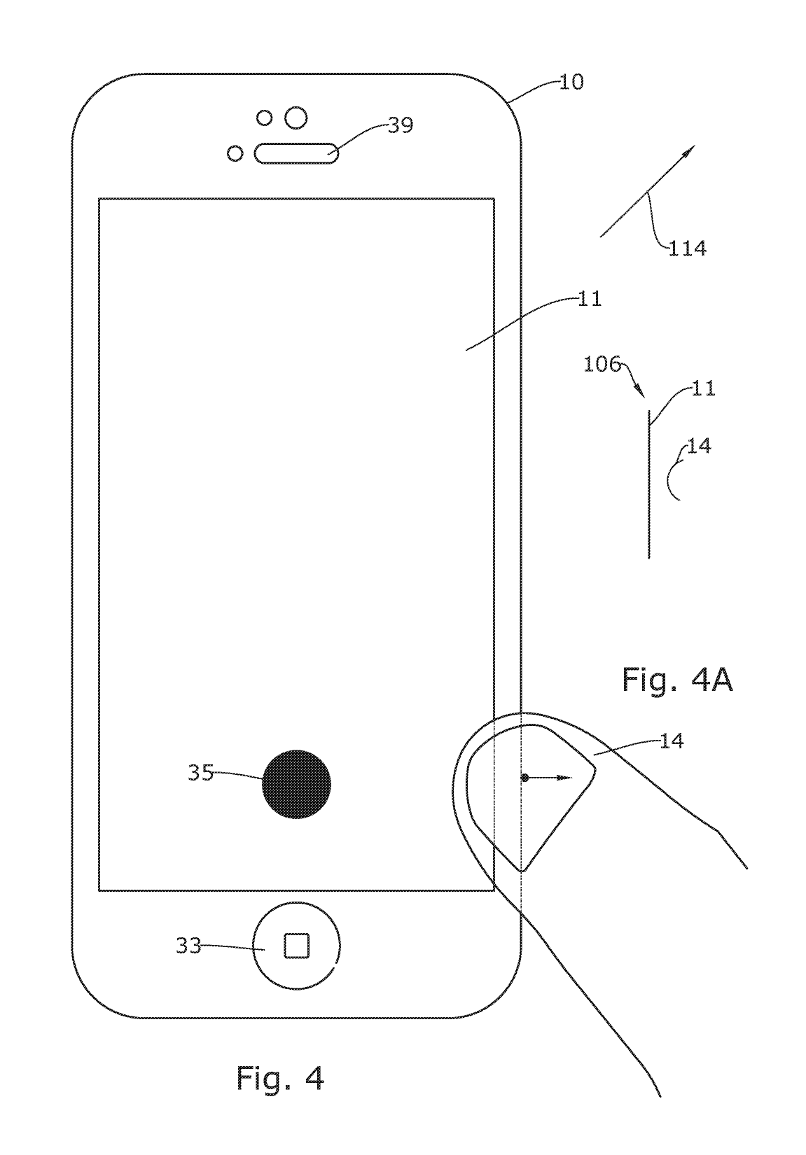

Referencing FIG. 4, the reader will there see a depiction of a no-contact or member-removed scenario 106. The user has removed the contacting member as exemplified by a fingertip 14 from the visual prompt 35, which contact removal or release event 106 initiates a further proactive or action-based computer function. In this scenario, the contact removal or release event 106 initiates or activates a media send/share function (i.e. a fifth computer function) and the displayed and reviewed photograph or video 44 is sent to or shared with (as at arrow 114) a preset group or individual in communication with the mobile communications device 10 and in cooperation with the mobile application of software tool according to the present invention. Central to the practice of the present invention are the high force 103 pressure contact event 102 and contact release or member-removed event 106 as triggers for computer functionality.

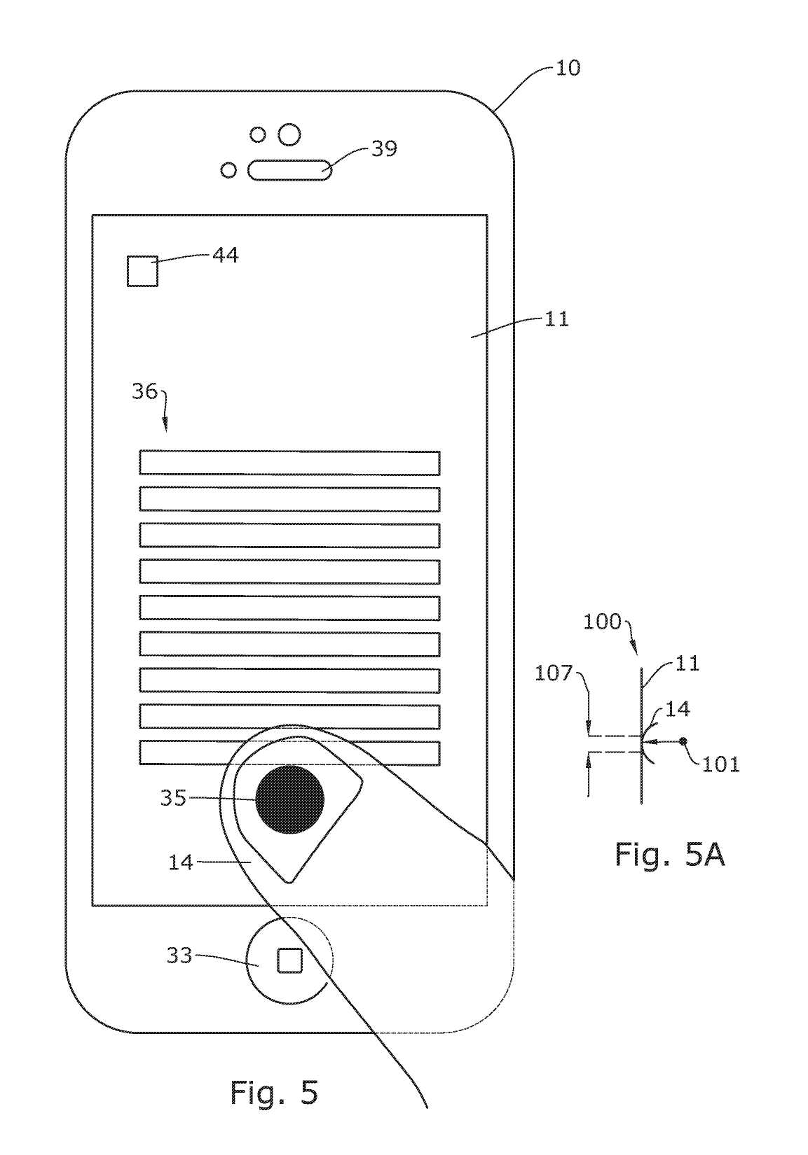

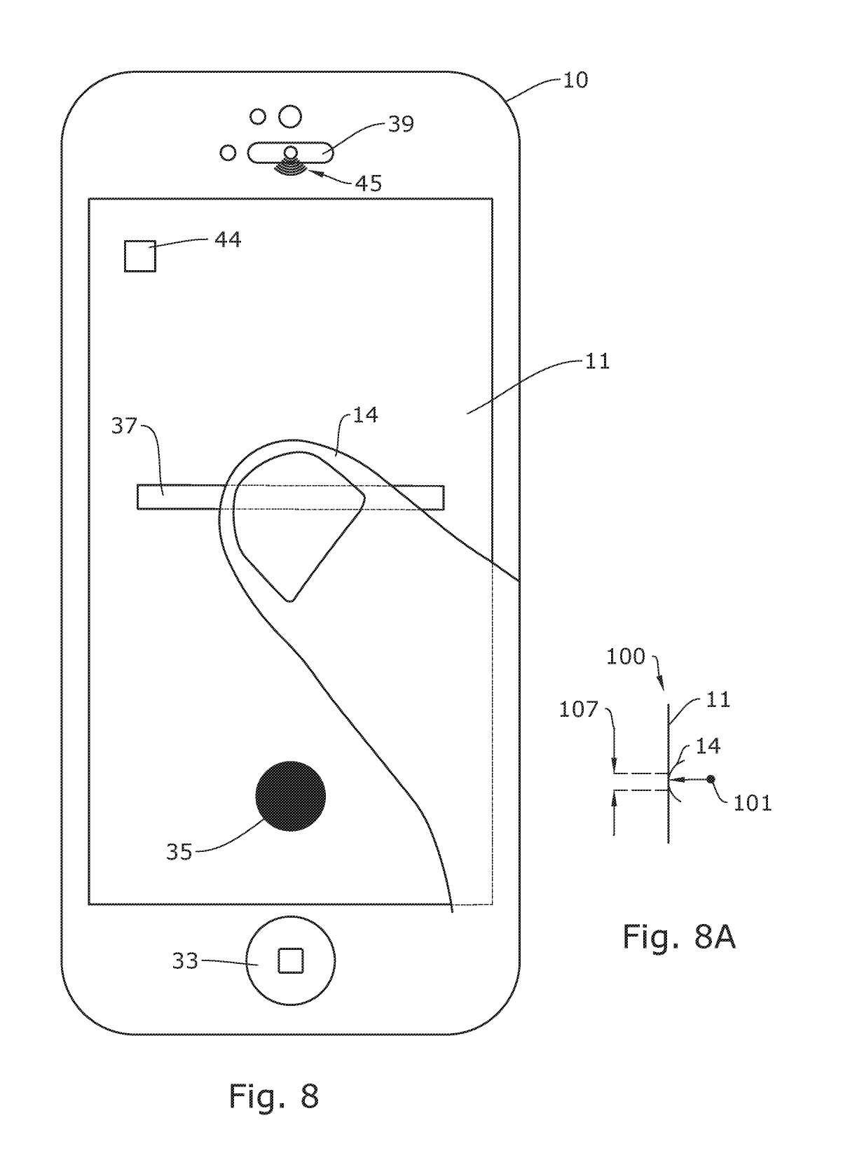

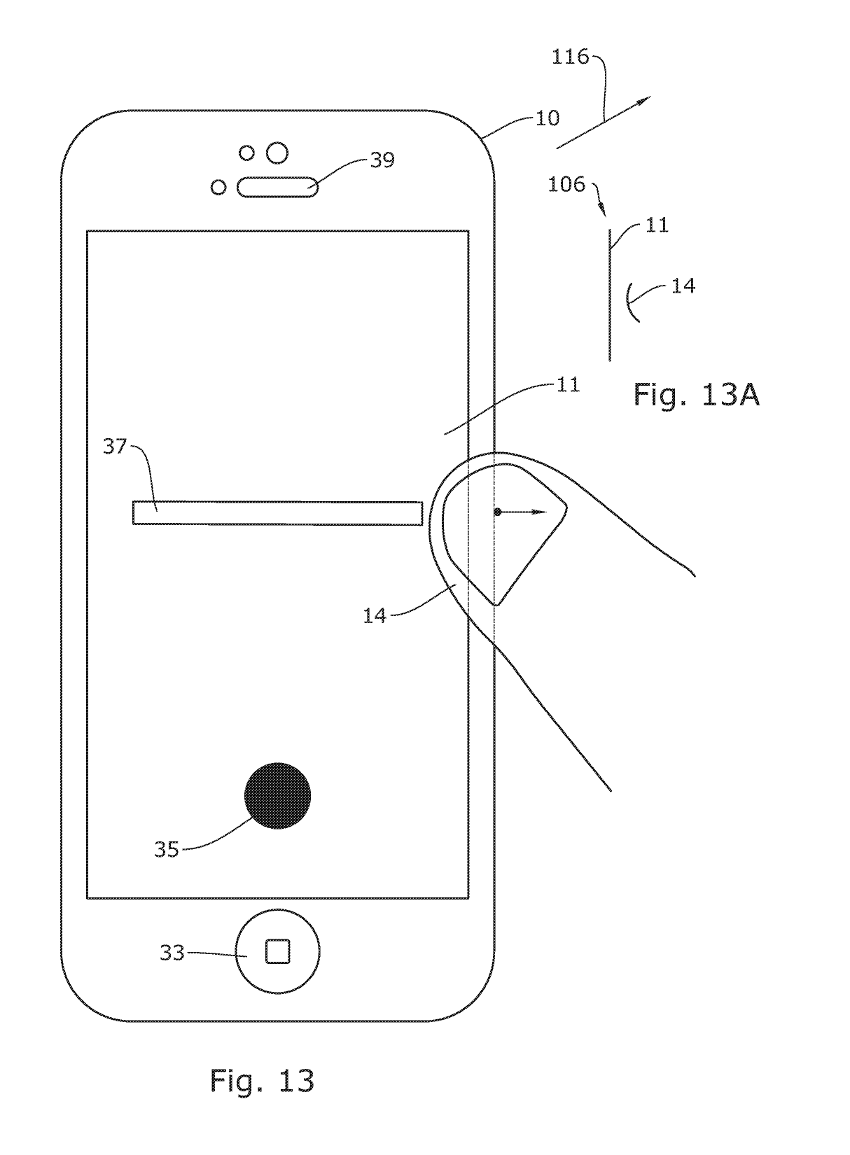

Referencing FIGS. 5-13, the reader will there comparatively consider further exemplary computer or device functionality directed to menus or collections of files as exemplified by a music or audio file playlist visual prompt as at 36. In this regard, it is contemplated that user may wish to attach an audio file to the photograph or video packet 44 generated from events depicted in FIGS. 1-3 (i.e. those functions occurring before the send/share function 114 as generally depicted in FIG. 4). In the follow up functional scenarios depicted in FIGS. 5-13, the user may initiate further functionality with a low force 101 simple contact 100 at the site of the visual prompt 35 which contact activates the music or audio file playlist or menu prompt 36 as generally depicted in FIG. 5.

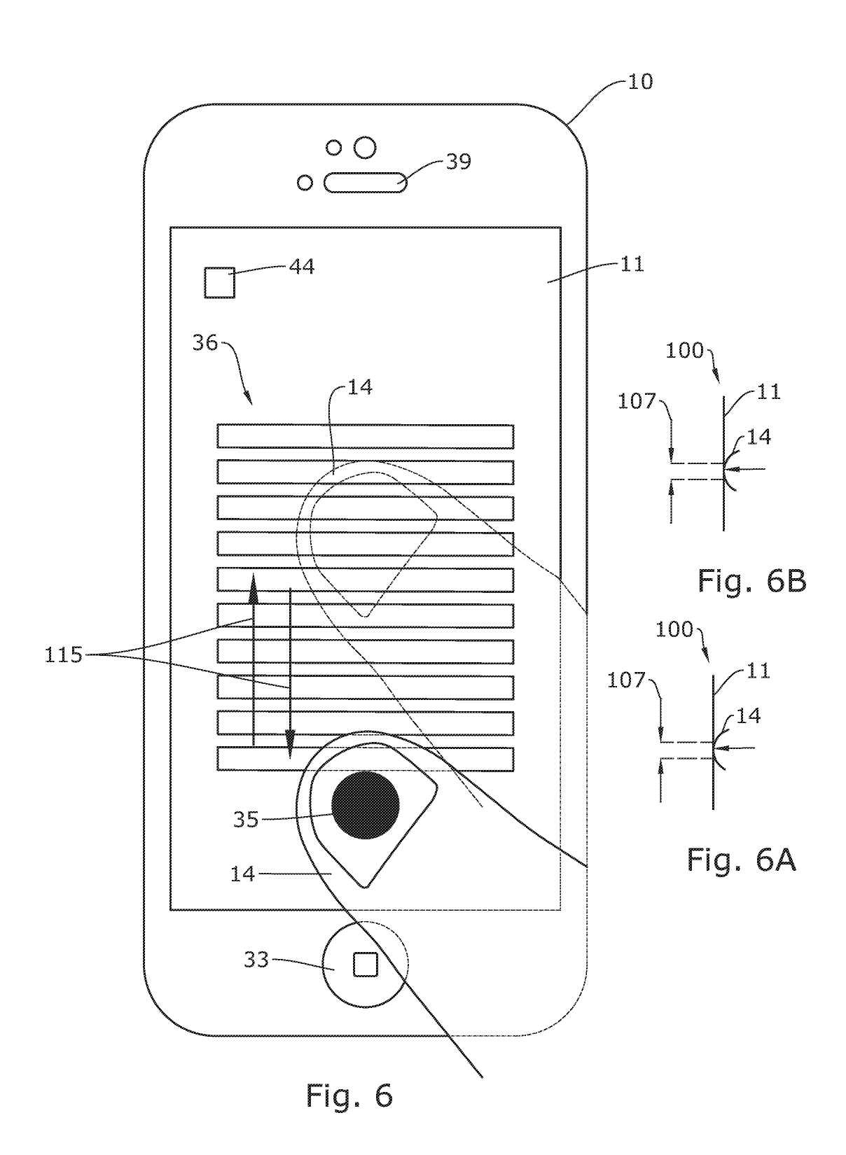

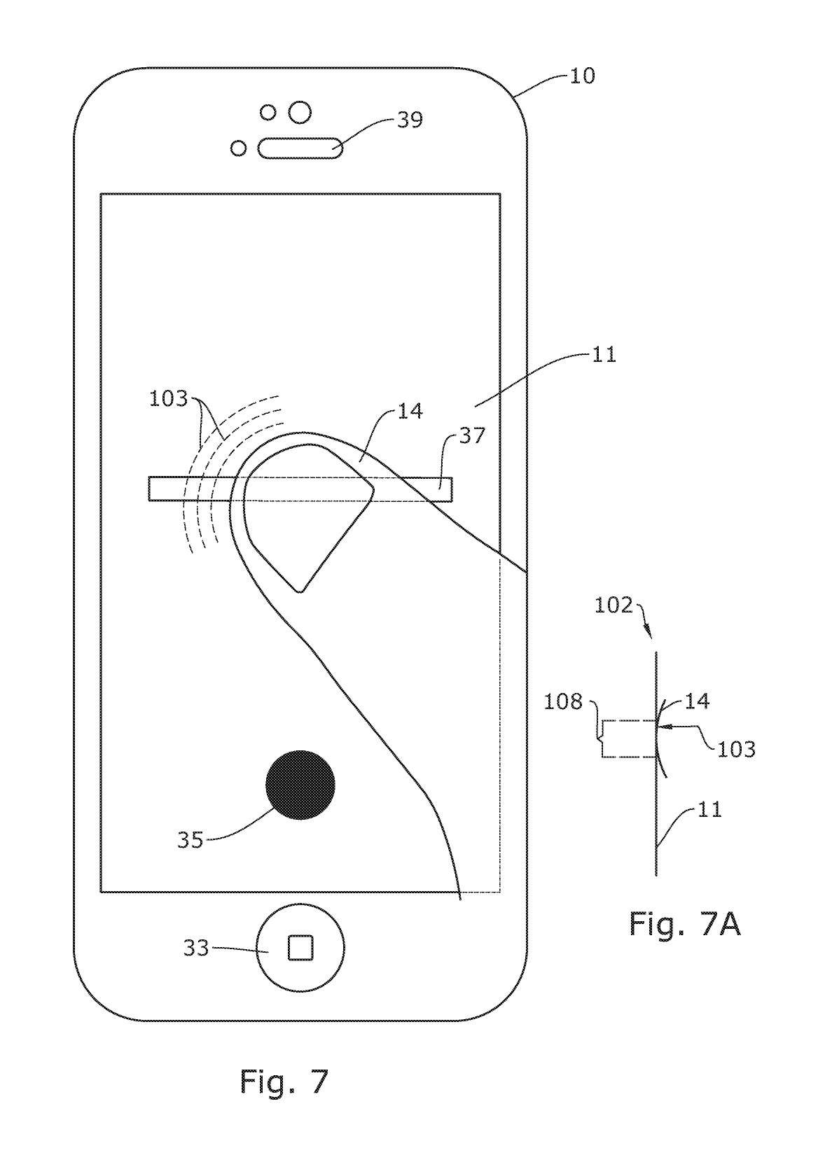

Comparatively referencing FIG. 6, the user, while maintaining a low force 101 simple contact 100 with touchscreen 11, may scroll through (as at arrows 115) the music or audio file playlist or menu visual prompt 36 for the purpose of locating a select music or audio file visual prompt 37 from the music or audio file playlist or menu visual prompt 36 as further generally and comparatively depicted in FIG. 7. Once the desired or select music or audio file visual prompt 37 is located, the user may initiate a high force 103 pressure contact 102 at the site of the select music or audio file visual prompt 37 to select the associated music or audio file content stored at or accessible via the mobile communications device 10.

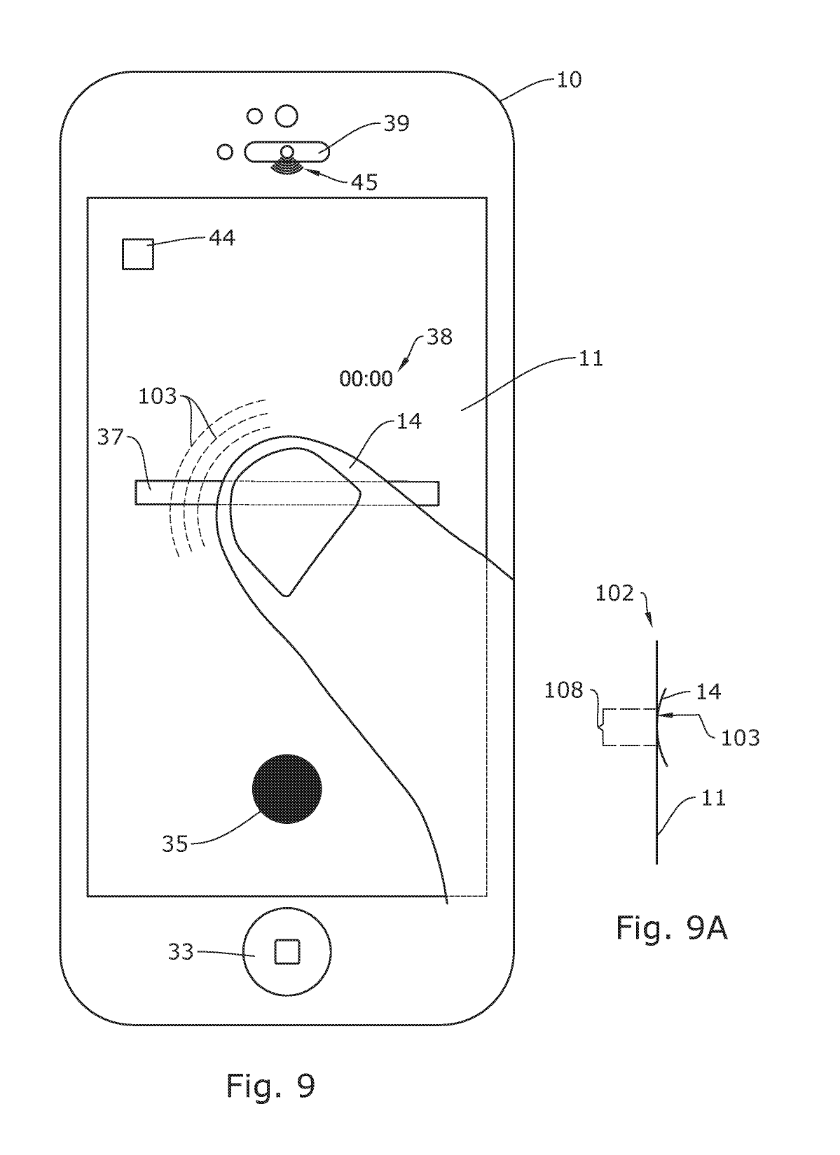

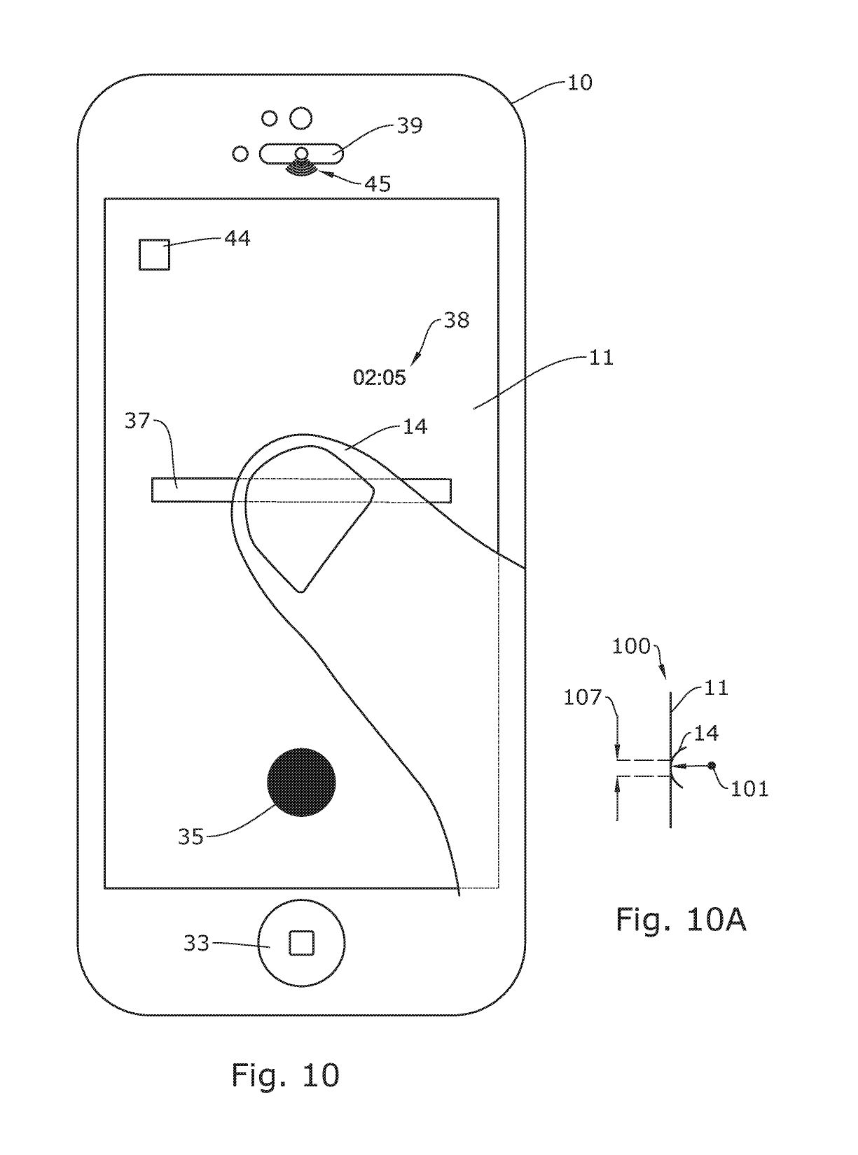

After selecting the music or audio file content via a high force 103 pressure contact scenario 102 atop the visual prompt 37, the user may then decrease the magnitude of force directed into the touchscreen 11 and revert back to a low force 101 simple contact scenario 100 at the site of the select music or audio file visual prompt 37 for music or audio file playback or review functionality as at 45. Referencing FIG. 9, the user may initiate or begin a desired playback 45 segment by increasing force directed into the touchscreen 11 or by initiating a high force 103 pressure contact 102 at the site of the visual prompt 37 at which time a timer visual indicator 38 may be displayed upon the electronic visual display 12 for time-stamping the beginning of a desired audio file segment as at 00:00 in FIG. 9. FIG. 10 depicts a decreased force or low force 101 simple contact-maintained scenario 100 for further music or audio file playback or review 45 while the timer visual indicator 38 tracks elapsed time as at 02:05 in FIG. 10. Audio playback 45 may be effected by way of a speaker feature 39 cooperably associated with the mobile communications device 10 and in communication with the information processing system 13.

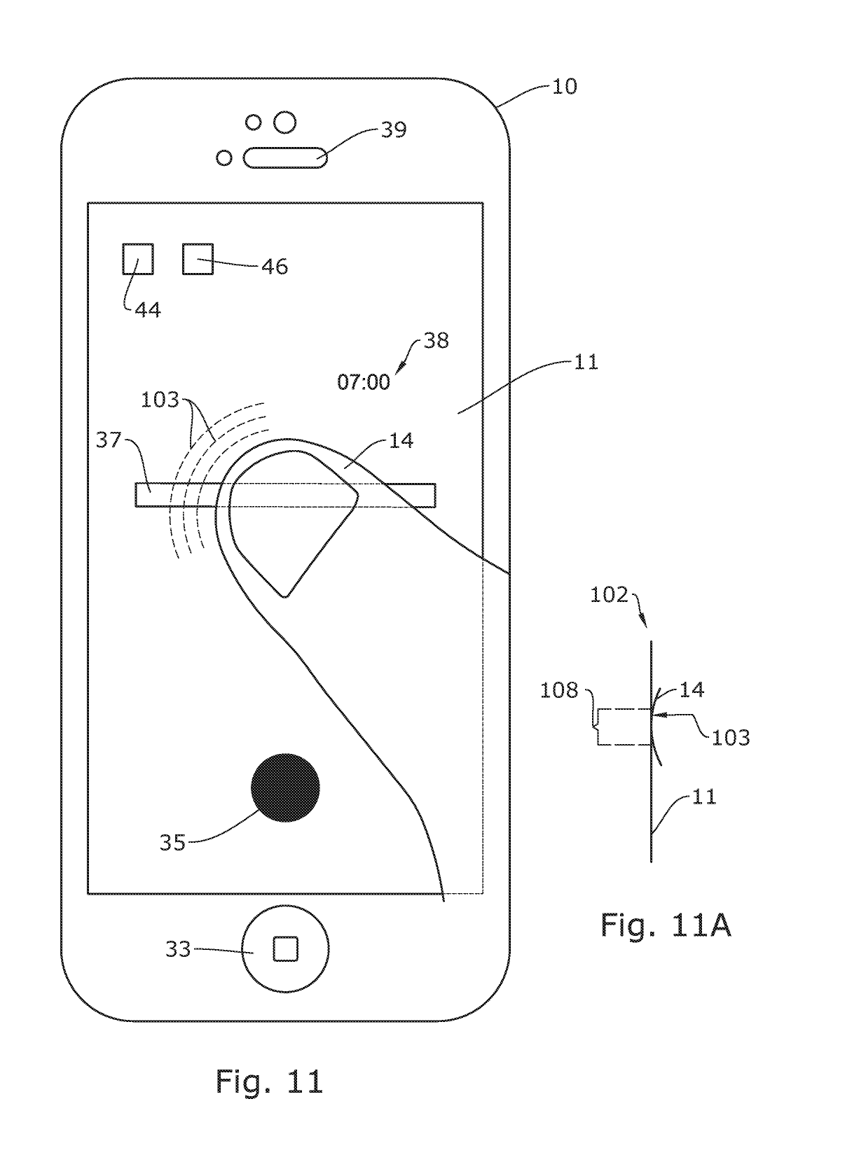

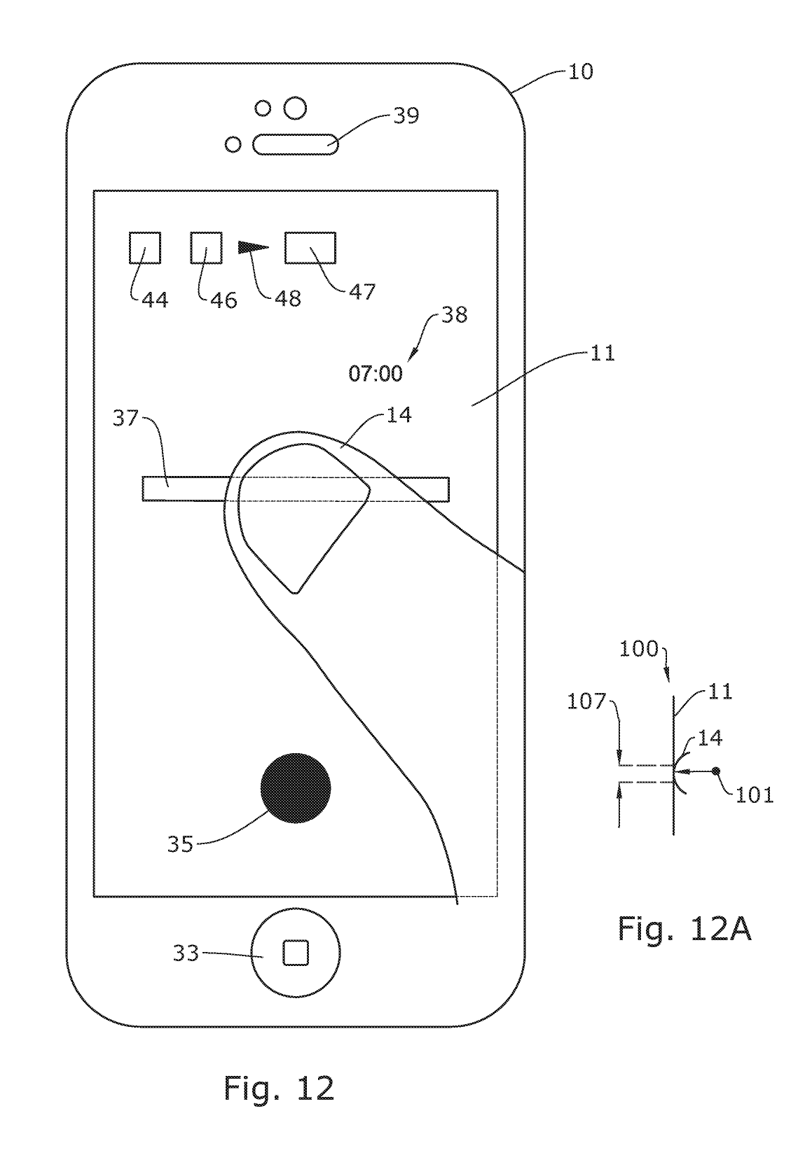

At the end of the desired timed segment of music or audio file playback or review 45 as visually indicated by the timer visual indicator 38 set at 07:00 in FIG. 11, the user may increase force directed into the touchscreen 11 or initiate a high force 103 pressure contact scenario 102 for ending the playback or review 45 and forming or finalizing a music or audio file segment or packet 46 governed or capped by time-stamps visually enabled or indicated via the timer visual indicator 38. By subsequently decreasing force directed into the touchscreen 11 or initiating a low force 101 simple contact scenario 100, the user may thereby attach (as at arrowhead 48) the timed music or audio file segment 46 to a photograph or video (as at 44) for forming a photograph/video—music/audio file combination packet 47 as generally and comparatively depicted in FIG. 12.

By removing contact or initiating a contact-release event as at member-removed scenario 106, the user thereby triggers, initiates or activates a multimedia send/share function and the photograph/video—music/audio file combination packet 47 is sent to or shared with (as at arrow 116) a preset group or individual in communication with the mobile communications device 10 and in cooperation with the mobile application of software tool according to the present invention. Should the user wish to add additional content to the packet 47 such as an audio commentary, the reader may maintain contact with the touchscreen 11 instead of initiating a contact-release event as at member-removed scenario 106.

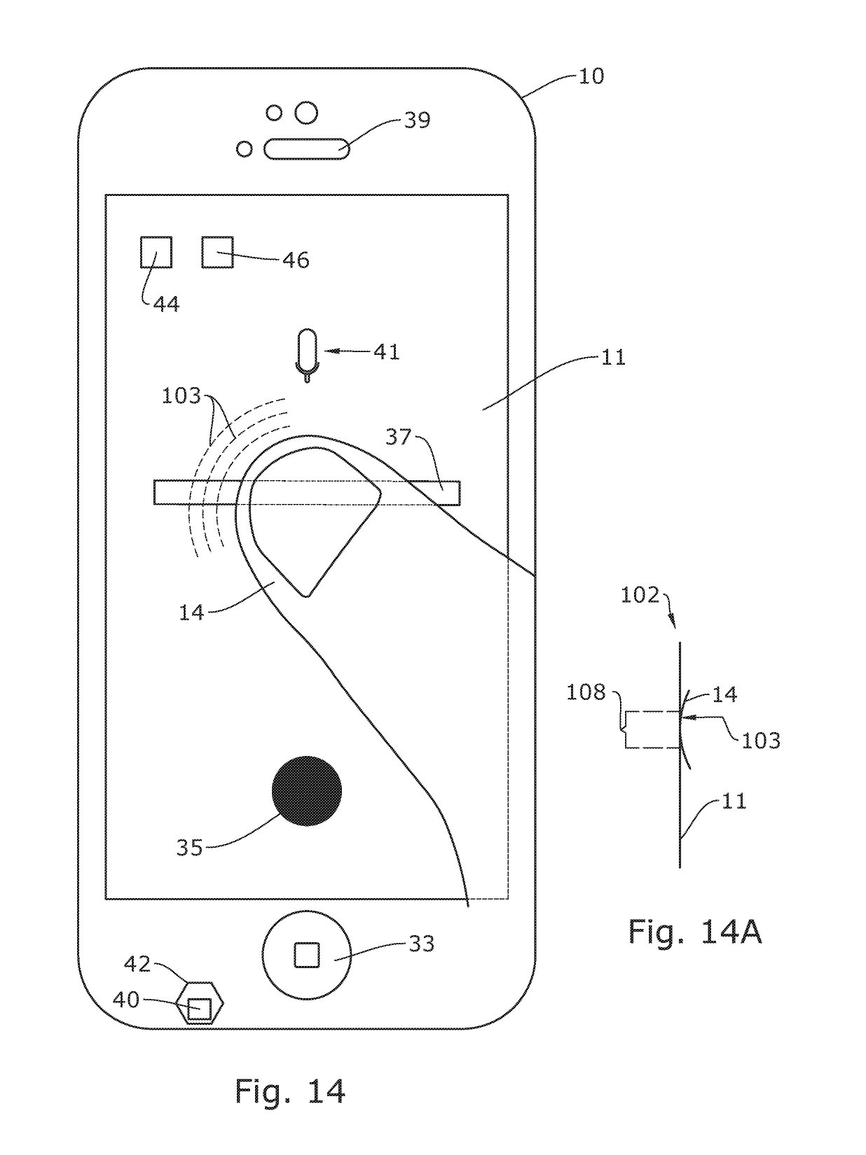

In this regard, reference is made to FIG. 14 which figure depicts an increase of force directed into the touchscreen 11 or a high force 103 pressure contact scenario 102 following the low force 101 simple contact scenario 100 generally depicted in FIG. 12. This force-press event may trigger, initiate or activate an audio commentary function whereby a microphone or audio data intake/input feature 40 (within hexagonally shaped breakaway 42) cooperably associated with the mobile communications device 10 and in communication with the information processing system 13 may be activated for the purpose of enabling the user to input or record audio commentary. A microphone visual indicator 41 may also be displayed upon the electronic visual display 12 to alert the user to this feature activation.

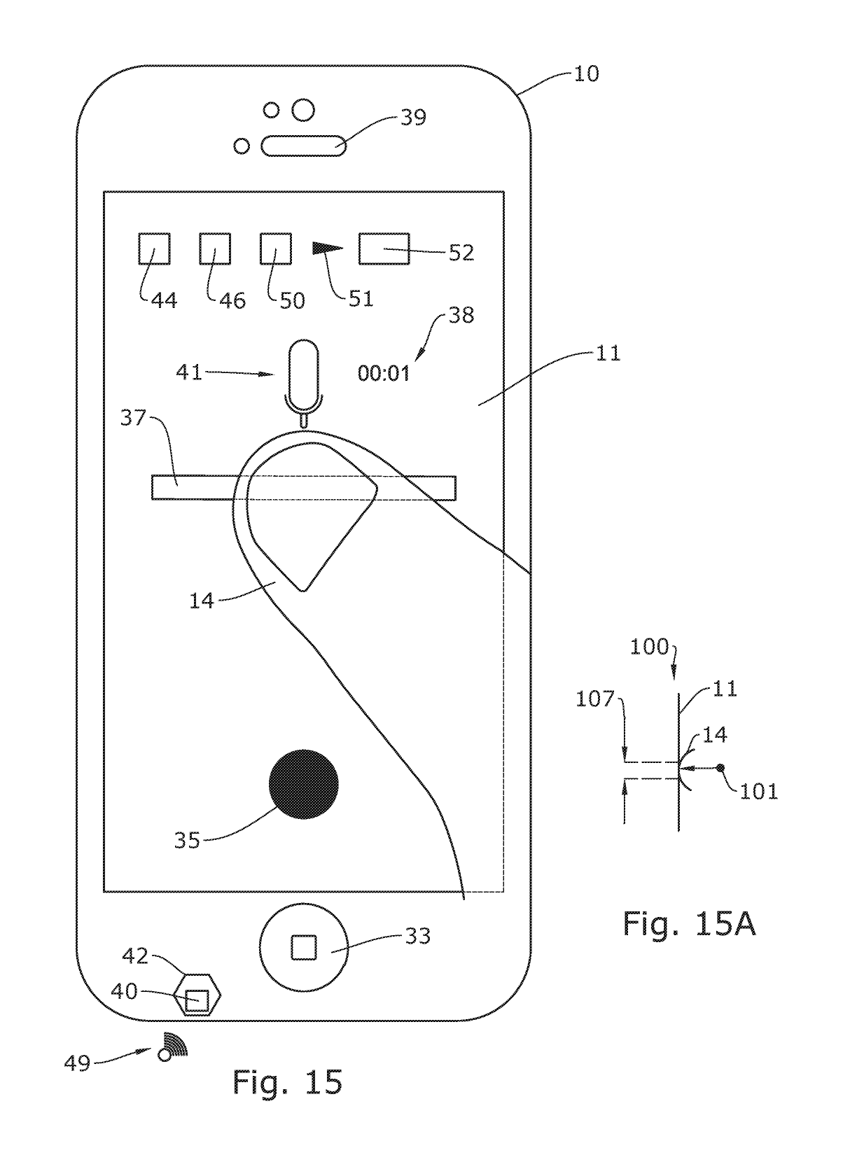

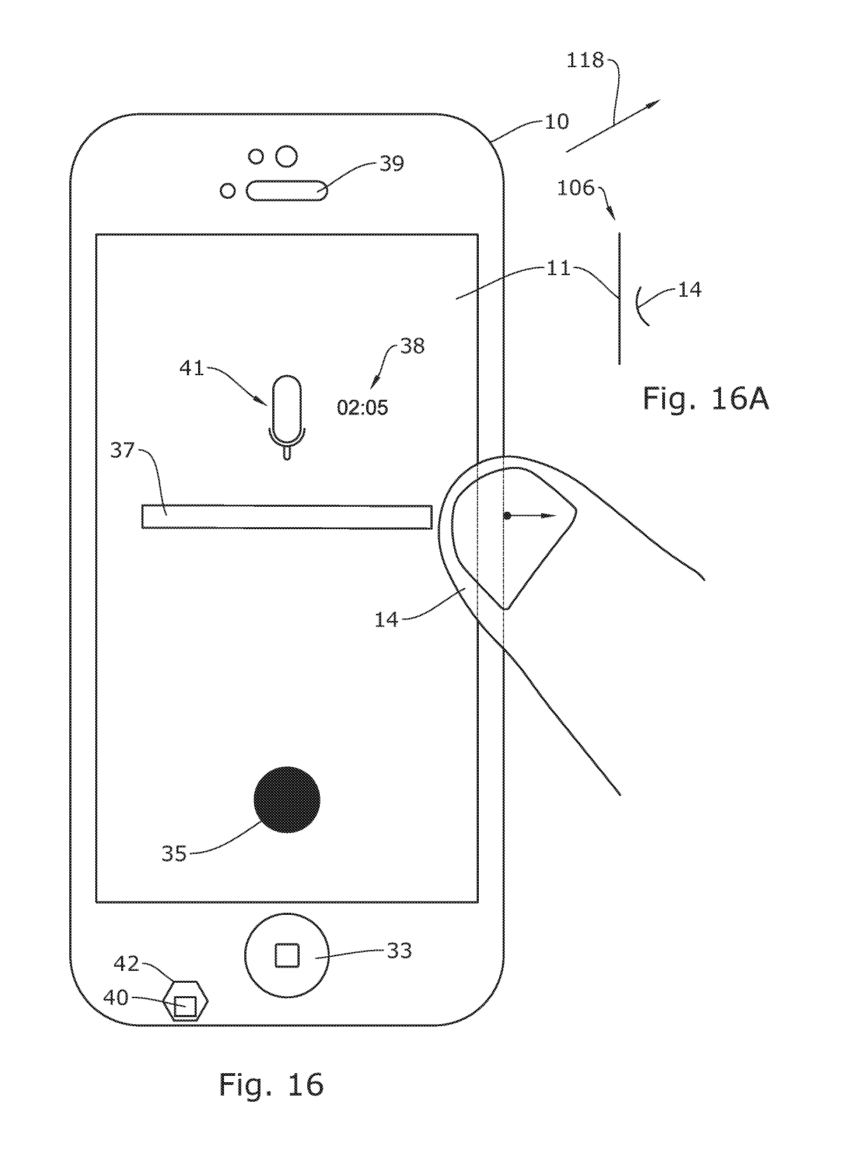

With a decrease in force directed into the touchscreen or a low force 101 simple contact scenario 100 following the high force 103 pressure contact scenario 102 in FIG. 14, the user may record an audio commentary as at 49 by maintaining a low force 101 simple contact 100 with the select music or audio file prompt 37 and splice or overlay the audio commentary packet or file 50 onto the underlying music or audio file segment or packet 46 by way of time-stamp signatures enabled and as visually indicated at the time visual display 38. By removing contact or initiating a contact-release event as at member-removed scenario 106, the user thereby triggers, initiates or activates a multimedia send/share function and a photograph/video—music/audio file—audio commentary combination packet 52 formed as at arrowhead 51 is sent to or shared with (as at arrow 118) a preset group or individual in communication with the mobile communications device 10 as generally and comparatively depicted in FIGS. 15 and 16. It is contemplated that the formation 51 of the packet 52 may be effected by way of a high force 103 pressure contact 102 before the release event 106 depicted in FIG. 16 (not specifically illustrated).

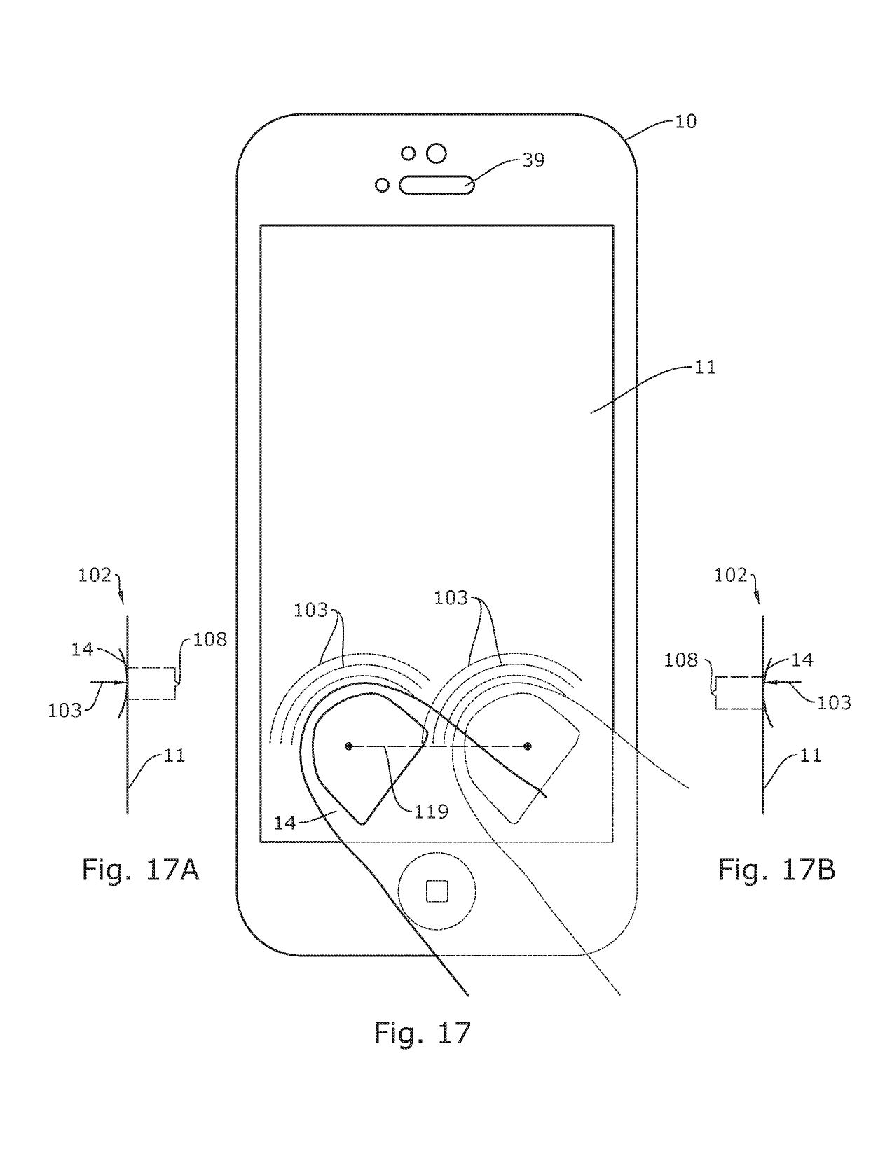

Referencing FIG. 17, the reader will there see a lateral displacement as at 119 of the contacting member exemplified by a fingertip 14 while in a high force 103 pressure contact scenario 102. As with state of the art touchscreen swipe technology, the user may scroll through photographs, videos, albums, music tracks, lists, etcetera by maintaining contact with the touchscreen 11 and re-positioning the contacting member or fingertip 14 relative to the vertical and/or horizontal dimensions of the touchscreen 11. According to the mobile application or software tool according to the present invention, however, the user may sequence through low force 101 simple contact scenarios 100 and high force 103 pressure contact scenarios 102 while so scrolling/swiping for adding a layer of functionality to or over state of the art touchscreen swipe methodology.

While the above descriptions contain much specificity, this specificity should not be construed as limitations on the scope of the invention, but rather as an exemplification of the invention. For example, it is contemplated that the mobile application or software tool according to the present invention essentially provides a device-implemented or computer-implemented method and/or system for sharing multimedia content such as photographs, videos, and audio files such as music files and the like with optional additional audio commentary. The device-implemented or computer-implemented method according to the present invention may be said to basically and essentially comprise a number of steps performable by a mobile communications device or computer.

In other words, the machine-implemented or computer-implemented methods according to the present invention are operable by way of a mobile communications device or computer. Installed on such a device, the mobile application or software tool according to the present invention may be initially launched by a user under state of the art techniques upon a mobile communications device as at 10, which mobile communications device 10 necessarily comprises or includes a touchscreen as at 11, a visual display as at 12, and a device-contained information processing system or central processing unit as at 13. Further, the device 10 may essentially comprise a microphone or audio input feature as at 40.

When launched, the mobile application or software tool according to the present invention may prompt the user with a visual prompt (as at 35) upon the visual display 12 for effecting some computer function then in a ready state for activation by way of a touch or low force contact at the visual prompt site. The user may then touch or initiate contact with the touchscreen 11 at the visual prompt 35 thereby initiating a first mobile application or computer-based function from the ready state start screen. The first mobile application or computer-based function may thus be the capture of a photograph or the start of a video recording as exemplified by the foregoing descriptions.

It will be understood that the first mobile application or computer-based function is initiated by way of a first type of touch-sensing system (i.e. a contact-sensing system) cooperable with the touchscreen and driven or governed by the information processing system. The touchscreen may then be pressed for effecting a pressure contact and registering the same for initiating a second mobile application or computer-based function successive to the first mobile application or computer-based function such as review of the captured photograph or video recording. Notably, the second mobile application or computer-based function successive to the first function is initiated or activated by a second type of touch-sensing system (i.e. a pressure-sensing system) cooperable with the touchscreen and driven by the information processing system.

A high force or pressure scenario may be followed by a decrease in force or pressure while maintaining a low force simple contact with the touchscreen for initiating or activating a third mobile application or computer-based function such as recording an audio commentary of the reviewed visual content for sharing with others. Notably, the third mobile application or computer-based function is initiated or activated by the first type of touch-sensing system characterized by a low force simple contact-sensing system. The touchscreen may again be pressed with a high force pressure contact for initiating or activating a fourth mobile application or computer-based function or creating a sharable multimedia packet comprising the visual and audio commentary for sharing with others. The fourth mobile application function in this scenario is initiated by the second type of touch-sensing system characterized by a high force pressure contact-sensing system.

The foregoing summaries generally describe in a broader manner an exemplary method or series of steps enabled by the present invention. Stated another way, the present invention is believed to basically and essentially provide a computer implemented method or system for sharing multimedia content as exemplified by, but not limited to photographs, videos, audio files inclusive of music, and audio commentary. The computer implemented method may be said to comprise the steps of initiating executable instructions of a non-transitory computer readable medium or of a mobile application of software tool via an information processing system of a mobile device having a touchscreen with both simple contact-sensing and pressure contact-sensing operability and an electronic visual display.

A visual prompt may be displayed upon the electronic visual display via the touchscreen and the touchscreen may be touched with a low force simple contact at the site of the visual prompt with a contacting member such as fingertip for initiating a first computer function. The touchscreen may then be pressed with a high force pressure contact at the site of the visual prompt with the contacting member for initiating a second computer function sequentially and successively related to the first function. When the (fingertip) contacting member is released from the touchscreen, a third computer function may thereby be initiated or activated such as sending or sharing a multimedia packet formed by way of the first and second computer functions effected by simple and pressure contacts with the touchscreen.

The mobile device operating to implement the method may comprise a single touchscreen assembly having dual touch-sensing or contact-sensing systems cooperable therewith and governed by the information processing system that is operable to register both a low force simple contact and a high force pressure contact. Alternatively, the touchscreen assembly may comprise at least two touch-sensing systems cooperable with the touchscreen and governed by the information processing system, whereby a first computer-based function may be initiated by a first of the at least two touch-sensing systems and a second computer-based function may be initiated by a second of the at least two touch-sensing systems. The first, second, and third computer-based functions may be respectively characterized or defined by the processes of inputting multimedia content, reviewing multimedia content, and sending/sharing multimedia content.

The computer implemented method further contemplates certain additional steps following a high force pressure contact step, which steps may include decreasing directed force into the touchscreen while maintaining contact with the touchscreen. These steps may well operate to initiate additional computer functions sequentially successive or iterative to prior computer function such as selecting a portion of the reviewing material (i.e. a timed segment of a musical track as at packet 46) for further sharing. A high force pressure contact may then be initiate for finalizing or selecting an end portion of the content to be shared before the final function or send/share function is implemented by way of the contact release step.

The computer implemented method according to the present invention thus further contemplates repeatable steps following the steps of decreasing directed force into the touchscreen and maintaining contact with the touchscreen, which repeatable steps comprise the steps of increasing and decreasing directed force into the touchscreen for initiating additional computer functions sequentially successive or iterative of other computer functions precedent to the final contact release event. The computer implemented method according to the present invention further contemplates the physical step of deforming a select structure at the member-to-screen interface (i.e. the touchscreen), which select structure may be selected from the group consisting of the touchscreen and the contacting member for initiating the second computer function. In other words, either the touchscreen or the contacting member may be deformed to varying degrees for effecting varying functions registrable via touchscreen contact and as processed via the information processing system.

Viewed systemically, the present invention may be said to provide a computer-based system for performing successive or iterative computer functions. The computer-based system according to the present invent may thus be said to basically and essentially comprise a computer and a non-transitory computer readable medium with computer driving instructions. The computer comprises a touchscreen assembly (inclusive of an electronic visual display), and an information processing system in communication with one another. The non-transitory computer readable medium has certain executable instructions, which when executed by the information processing system cause the computer-based system to perform certain computer-based functions.

For example, together the computer and non-transitory computer readable medium with executable instructions may cooperate to display at least one visual prompt upon the electronic visual display and initiate a first computer function when a contact member contacts the touchscreen. A second computer function sequentially successive to the first computer function may be initiated or activated when directed force into the touchscreen is increased via the contact member. Finally, a third computer function sequentially successive to the second computer function may be initiated or activated when directed force into the touchscreen is decreased via the contact member. The executable instructions when executed by the information processing system may further and preferably cause the computer-based system to initiate a fourth computer function sequentially successive to the third computer function when contact with the touchscreen via the contact member ceases.

The computer-based system according to the present invention contemplates the incorporation of either (a) a touch-sensing system cooperable with the touchscreen and governed by the information processing system operable to register both a low force simple contact and a high force pressure contact, or (b) at least two touch-sensing systems cooperable with the touchscreen and governed by the information processing system, whereby a first computer-based function may be initiated by a first of the at least two touch-sensing systems and a second computer-based function may be initiated by a second of the at least two touch-sensing systems.

The computer-based system may include or provide a deformable touchscreen such that the executable instructions when executed by the information processing system cause the computer-based system to perform select computer functions when directed force into the touchscreen deforms at least a portion of the touchscreen. Alternatively, the executable instructions when executed by the information processing system may cause the computer-based system to perform select computer functions when at least a portion of the contacting member deforms under directed force into the touchscreen, which deforming contacting member alters or changes the contact surface area between the contacting member and the touchscreen which change is registrable and operates to initiate certain select computer functions.

Still further, the computer implemented method according to the present invention may well be practices for performing iterative computer functions by way of auditory input intensities. In this regard, the computer implemented method may be said to essentially and basically comprise the step of initially inputting a continuous, first auditory input (e.g. a relatively low intensity auditory input 54) into a computer device as at 10 via the microphone or audio input feature 40 for initiating a first computer function as variously exemplified and interrupting (i.e. breaking or ceasing by reducing the audio intensity to imperceptible threshold 57) the continuous, first auditory input into the computer device for initiating a second computer function sequentially successive to the first computer function.

The computer implemented method may further comprise the steps of increasing auditory input intensity into the computer device for initiating a third computer function sequentially successive to the first computer function and precedent to the second computer function and decreasing auditory input intensity into the computer device for initiating a fourth computer function sequentially successive to the third computer function and precedent to the second computer function, which steps may then be repeated for triggering or initiating additional computer functions sequentially successive to the first computer function and precedent to the second computer function.

Accordingly, although the inventive touchscreen-based methods and systems have been described by reference to a number of varying exemplary methods and/or systems, it is not intended that the touchscreen-based methods and systems be limited thereby, but that modifications thereof are intended to be included as falling within the broad scope and spirit of the foregoing disclosure, the following claims, and the drawings, both diagrammatic and illustrative, submitted in support of these specifications.

What is claimed is:

1. A computer-touchscreen implemented method for processing successive computer functions via a computer and a touchscreen, the computer-touchscreen implemented method comprising the steps of:
initiating executable instructions of a non-transitory computer readable medium via an information processing system of a mobile computer device, the mobile computer device comprising the touchscreen and a visual display;
contacting the touchscreen with a contacting member at a visual prompt displayed upon the visual display by way of the initiated executable instructions thereby activating a first computer function;
directing force into the touchscreen at the visual prompt with the contacting member thereby activating a second computer function successive to the first computer function; and
releasing the contacting member from the touchscreen at the visual prompt thereby activating a third computer function successive to the second computer function.

2. The computer-touchscreen implemented method of claim 1 wherein the first, second, and third computer functions are respectively defined by the processes of inputting multimedia content, reviewing multimedia content, and sharing multimedia content.

3. The computer-touchscreen implemented method of claim 1 wherein the mobile computer device comprises at least two contact-sensing systems cooperable with the touchscreen and governed by the information processing system, the first computer function being initiated by a first of the at least two contact-sensing systems and the second computer function being initiated by a second of the at least two contact-sensing systems.

4. The computer-touchscreen implemented method of claim 1 comprising additional steps following the step of directing force into the touchscreen at the visual prompt, the additional steps comprising the steps of:
decreasing directed force into the touchscreen; and
maintaining contact with the touchscreen, said steps for initiating a fourth
computer function sequentially successive to the second computer function.

5. The computer-touchscreen implemented method of claim 4 comprising repeatable steps following the steps of decreasing directed force into the touchscreen and maintaining contact with the touchscreen, the repeatable steps comprising the steps of increasing and decreasing directed force into the touchscreen for initiating additional computer functions sequentially successive to the fourth computer function and precedent to the second computer function.

6. The computer-touchscreen implemented method of claim 1 comprising the step of deforming a select structure at a member-to-screen interface, the select structure being selected from the group consisting of the touchscreen and the contacting member for initiating the second computer function.

7. The computer implemented method of claim 1 comprising the steps of:
maintaining directed force into the computer touchscreen after increasing directed force into the computer touchscreen while displacing the contact member across the computer touchscreen for initiating a fifth computer function sequentially successive to the second computer function and precedent to the third computer function.

8. A computer-based system for performing iterative computer functions, the computer-based system comprising:
a computer, the computer comprising a touchscreen, a visual display, and an information processing system in communication with one another; and
a non-transitory computer readable medium, wherein the non-transitory computer readable medium comprises executable instructions which when executed by the information processing system cause the computer-based system to:
initiate a first computer function when a contact member contacts the touchscreen;
initiate a second computer function sequentially successive to the first computer function when directed force into the touchscreen is increased via the contact member; and
initiate a third computer function sequentially successive to the second computer function when directed force into the touchscreen is decreased via the contact member.

9. The computer-based system of claim 8 wherein the executable instructions when executed by the information processing system cause the computer-based system to initiate a fourth computer function sequentially successive to the third computer function when contact with the touchscreen via the contact member ceases.

10. The computer-based system of claim 8 comprising at least two contact-sensing systems cooperable with the touchscreen and information processing system for governing touchscreen control, a first of the at least two contact-sensing systems for sensing touchscreen contact and a second of the at least two touch-sensing systems for sensing touchscreen pressure.

11. The computer-based system of claim 8 wherein the executable instructions when executed by the information processing system cause the computer-based system to initiate additional computer functions sequentially successive to the third computer function when contact-maintained directed force into the touchscreen is repeatedly increased and decreased.

12. The computer-based system of claim 8 wherein the touchscreen is deformable, the executable instructions when executed by the information processing system causing the computer-based system to perform select computer functions when directed force into the touchscreen deforms at least a portion of the touchscreen.

13. The computer-based system of claim 8 wherein the executable instructions when executed by the information processing system cause the computer-based system to perform select computer functions when at least a portion of the contacting member deforms under directed force into the touchscreen, the deforming contacting member altering contact surface area between the contacting member and the touchscreen, the altered contact surface area for initiating the select computer functions.

14. A computer implemented method for performing iterative computer functions, the method comprising the steps of:
contacting a computer touchscreen for initiating a first computer function; and
removing contact from the computer touchscreen for initiating a second computer function sequentially successive to the first computer function.

15. The computer implemented method of claim 14 comprising the steps of:
increasing directed force into the computer touchscreen for initiating a third computer function sequentially successive to the first computer function and precedent to the second computer function; and
decreasing directed force into the computer touchscreen for initiating a fourth computer function sequentially successive to the third computer function and precedent to the second computer function.

16. The computer implemented method of claim 15 whereby the first computer function is initiated by a first contact-sensing system cooperable with the touchscreen and the third computer function is initiated by a second contact-sensing system cooperable with the touchscreen.

17. The computer implemented method of claim 15 comprising the step of maintaining contact with the computer touchscreen after decreasing directed force into the computer touchscreen for initiating the fourth computer function.

18. The computer implemented method of claim 15 whereby the steps of increasing and decreasing directed force into the computer touchscreen may be repeated for initiating additional computer functions sequentially successive to the first computer function and precedent to the second computer function.

19. The computer implemented method of claim 15 wherein a select step coincides with a deformation of a select structure at a member-to-screen interface for initiating respectively iterative computer functions, the select step being selected from the group consisting of increasing directed force into the computer touchscreen and decreasing directed force into the computer touchscreen, the select structure being selected from the group consisting of the touchscreen and the contacting member.

20. The computer implemented method of claim 15 comprising the steps of:
maintaining directed force into the computer touchscreen after increasing directed force into the computer touchscreen while displacing the contact member across the computer touchscreen for initiating a fifth computer function sequentially successive to the third computer function and precedent to the fourth computer function.

21. A computer implemented method for performing iterative computer functions, the method comprising the steps of:
inputting a continuous, first auditory input into a computer device for initiating a first computer function; and
interrupting the continuous, first auditory input into the computer device for initiating a second computer function sequentially successive to the first computer function.

22. The computer implemented method of claim 21 comprising the steps of:
increasing auditory input intensity into the computer device for initiating a third computer function sequentially successive to the first computer function and precedent to the second computer function; and
decreasing auditory input intensity into the computer device for initiating a fourth computer function sequentially successive to the third computer function and precedent to the second computer function.

23. The computer implemented method of claim 22 whereby the steps of increasing and decreasing auditory input intensity into the computer device are repeated for initiating additional computer functions sequentially successive to the first computer function and precedent to the second computer function.
